(19) United States
(12) Patent Application Publication
(10) Pub. No.: US 2019/0295185 A1
(43) Pub. Date: Sep. 26, 2019

(54) Secure, Customizable and Efficient System for Charitable Organization

(71) Applicants: Samah Nabi, Marietta, GA (US); Tahsin Nabi, Marietta, GA (US)

(72) Inventors: Samah Nabi, Marietta, GA (US); Tahsin Nabi, Marietta, GA (US)

(21) Appl. No.: 16/436,426

(22) Filed: Jun. 10, 2019

Related U.S. Application Data
(60) Provisional application No. 62/787,677, filed on Jan. 2, 2019.

(51) Int. Cl. G06Q 40/00; G06Q 30/00; G06F 3/0482; G06F 3/0484

(52) U.S. Cl. CPC G06Q 40/123; G06Q 30/018; G06Q 2230/00; G06F 3/0484; G06F 3/0482

(57) ABSTRACT

A secure and efficient system for providing a customizable software for a charitable organization is disclosed. In one aspect, the said system facilitates the charitable organization to perform a plurality of required activities to stay compliant with federal, state and Internal Revenue Service (IRS) regulations and maintain the charitable organization's tax-exempt status associated with section 501 (c)(3) of the IRS Code. The plurality of required activities include, but are not limited to, performing actions associated with donations, expenses, filing tax returns, customizable reports, configuring entities, archiving documents, nomination and electronic voting. In another aspect, the said system provides only the features that the charitable organization needs instead of giving too many unwanted features, encrypts various data to enhance security, and stores the most frequently used data on the client to make the system faster and efficient. In another aspect, the said system uses both a web service method and a non-web service method to facilitate any type of client device to render the customizable software. In another aspect, the said system facilitates the charitable organization to customize any way that the charitable organization prefers, including the name of the software. A computer implemented method and a non-transitory machine-readable storage medium implementing the said secure and efficient system is also provided.

### CROSS-REFERENCE TO RELATED APPLICATION

This application claims the benefit of U.S. Provisional Patent Application Ser. No. 62/787,677 entitled “Secure, Customizable and Efficient System for Charitable Organization” filed Jan. 2, 2019, which is hereby incorporated by reference in its entirety.

### TECHNICAL FIELD

This invention relates to providing secure, customizable and efficient software solutions for charitable organizations so that the charitable organization can afford and easily perform their required activities to stay compliant with federal, state and Internal Revenue Service (IRS) regulations and maintain the charitable organization's tax-exemption status associated with, for example, section 501 (c)(3) of the Internal Revenue Code.

### BACKGROUND OF THE INVENTION

The techniques and methods stated in this section are not necessarily previously pursued or conceived. Thus, unless otherwise mentioned, it should not be assumed that any of the techniques and methods described in this section qualify as prior-art merely by virtue of its inclusion in this section.

One of the major contributors in turning the world into a better place is the presence of those who do charitable acts, come forward and help the people in need. These contributors are known as charitable organizations. Typically, the employees, officers, directors or trustees who run the organization do their work for free, spending their valuable time to help the people in need.

Every for-profit organization or corporation uses systems and software, which are very expensive [e.g. an Electronic Medical Record software may cost few hundred thousand USD] yet necessary to do their everyday work so that the organization or corporation can function efficiently. Like for-profit organizations, there are some systems and software available for charitable organizations, but those systems do not cater to the charitable organization's needs. Typically, these organizations use one system for accounting, one system for website, one system for file management, and one system for backend web portal. Further, those systems are very expensive for charitable organizations to buy and also filled with too many unwanted features. What we need is a single fully personalized and efficient software solution for charitable organizations to do all of their activities with ease. We need to give exactly what they need to perform their functions in a time effective and cost effective manner with prices that they can afford or for free if the charitable organization is unable to afford it.

In addition, there is no system available that is fully customizable for the client, e.g. personalize the name of the software/system for the organization. For example, when an organization buys a software called ‘MS Office’, there is no way to customize the name of the software and give full ownership to the organization. What we need is provide software solutions to charitable organizations and enable them to customize even the name of the software. This will make the organization give full ownership of the software.

Nowadays, users use different kinds of devices as clients to use software wherein devices include desktop, laptop, smart phone, tablet or any other portable device with a display. Based on the type of the client device, different software application is used, which is hard to manage and maintain. What is needed is to develop software system where the same source code can be served to render contents to multiple clients, which will make the system easy to maintain and serve any device that the user wants to use.

Typically, when organizations use developers to develop a website, developers charge the organization by the number of web pages that the organization wants to have. Every time the organization want to make changes, the organization needs to pay the developer/company a fee to make changes. What is needed is to render the software out of the enterprise level database to enable organizations to make changes on their own easily using a user interface and also enable them to add unlimited number of pages for free. As pointed out earlier, all of the employees of charitable organizations work voluntarily for free. They have no time to be overwhelmed with too many features and complexity. They need a system that is simple to use, functions effectively, and helps them to stay compliant with state and IRS requirements to maintain tax-exempt status.

Typically, charitable organizations update the content of their websites as needed, collect donations, send donation receipts to donors, disburse donations to recipients, produce annual reports for donors or for Certified Public Accountants (CPA), record meeting minutes, file 990 tax returns, nominate members for positions such as director/trustees/officer, conduct election said positions etc. As of now, there is no single system available that a non-profit organization can afford with a very minimum service charge or for free (for those who cannot afford) while still providing exactly what a charitable organization needs to function efficiently and effectively. Thus, we need a single system that enables organizations to create and update their website, record donations and expenses, produce various kinds of reports (e.g. annual report, donations by donors, donations by category, expense by project, expense by category or like based on the need), send donation receipts all donors of a given year by a single click, and generate IRS Form 990 on the fly based on the recorded data and file 990 to IRS in real time. With one system to take care of all of these functions, non-profit organizations will save a good amount of money that would have otherwise gone toward hiring a CPA to file their taxes.

### SUMMARY OF THE INVENTION

The present disclosure is directed to a system, a method and a computer-readable storage medium having machine readable instructions for providing a customizable software for a charitable organization to perform a plurality of required activities to stay compliant with federal, state and Internal Revenue Service (IRS) regulations and maintain the charitable organization's tax-exemption status associated with, for example, section 501 (c)(3) of the Internal Revenue Code. According to one aspect of the invention, the system includes a non-transitory memory for storing instructions to perform the plurality of required activities; and a processor, the processor configured to execute instructions to: receive a request from a client to render an authentication screen to access the customizable software wherein the request includes at least a unique identification number (UIN) assigned to the charitable organization; render the authentication screen dynamically to the client based on the UIN, the authentication screen includes at least a button control and a plurality of text box controls wherein the plurality of text box controls comprising at least a username text box control holding a username of a user and a password text box control holding a password of the user, wherein the username and the password is stored in a database in encrypted form; receive an user input to perform an authentication of the user using the UIN included in the request from the client, the username entered into the username text box control and the password entered into the password text box control, wherein the authentication matches the username and the password entered by the user with the username and the password value stored in the database in encrypted form, and the authentication uses a method from a plurality methods based on a type of the customizable software, wherein the plurality of methods comprises at least a Web Service method and a Non-Web Service method; identify, in response to have the user authenticated, a unique user identification (UID), a user role and an organization information of the authenticated user wherein the UID, the user role and the organization information are encrypted and stored at the client to avoid a client-server trip when the client needs to access the UID, the user role and the organization information; and render the customizable software to the client based on the identification of the UID, the user role and the organization information of the authenticated user, wherein the customizable software display at least: a logo information of the charitable organization, a customizable software name as per the charitable organization's preference in order to give full ownership of the customizable software, a version information of the customizable software, wherein the logo information, the software name and the version information is stored in the database and configurable by the charitable organization; and a menu bar including a plurality of menu items wherein the plurality of menu items are hierarchical and the plurality of menu items includes at least: a first menu to perform a first plurality of activities associated with donations received by the charitable organization; a second menu to perform a second plurality of activities associated with expenses done by the charitable organization; a third menu to perform a third plurality of activities associated with preparing and filing tax return to Internal Revenue Service (IRS); a fourth menu to perform a fourth plurality of activities associated with generating various customizable reports required by the charitable organization: a fifth menu to perform a fifth plurality of activities associated with configuring and customizing various data based on the charitable organization's requirements; a sixth menu to perform a sixth plurality of activities associated with archiving plurality of documents based on the charitable organization's requirements; and a seventh menu to perform a seventh plurality of activities associated with nomination and electronic voting of officers or directors of the charitable organization.

The details of one or more aspects of the invention are set forth in the accompanying drawings and the descriptions below.

### BRIEF DESCRIPTION OF THE DRAWING

FIG. 1 shows an exemplary system architecture for providing customized software for the charitable organization.

FIG. 2 shows a block diagram illustrating exemplary implementation of client and server shown in FIG. 1

FIG. 3 shows a block diagram illustrating exemplary computer system which can be used to implement client and server of FIG. 2

FIG. 4 shows an exemplary process of 400 for providing a customizable software for a charitable organization to perform a plurality of required activities to stay compliant with federal, state and Internal Revenue Service (IRS) regulations using exemplary client 101 and server 103 of FIG. 2

FIGS. 4A-4AL are exemplary screenshots associated with the exemplary process of FIG. 4

### DETAILED DESCRIPTION OF THE INVENTION

In this detailed description section, plurality of specific details has been set forth to give complete understanding of the present invention. It will be clear, however, a skilled artisan that embodiments of the present invention can be practiced and implemented without some of the specific details. In addition, well-understood concepts, techniques, structures and algorithm to one ordinarily skilled in the art has not been shown in detail or omitted to enhance readability of disclosure and not to obscure of the invention.

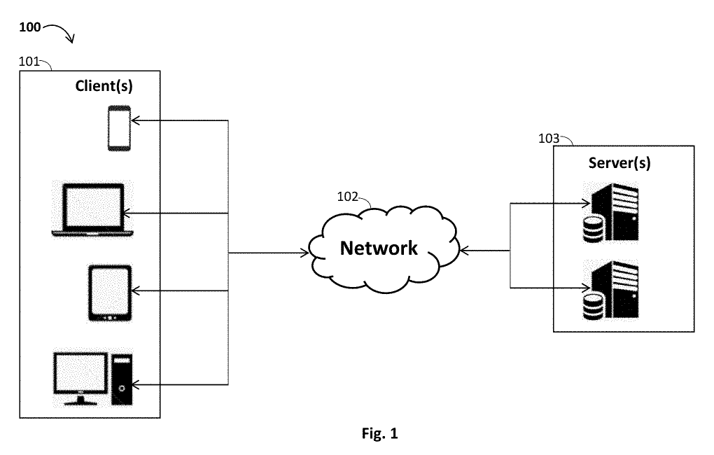

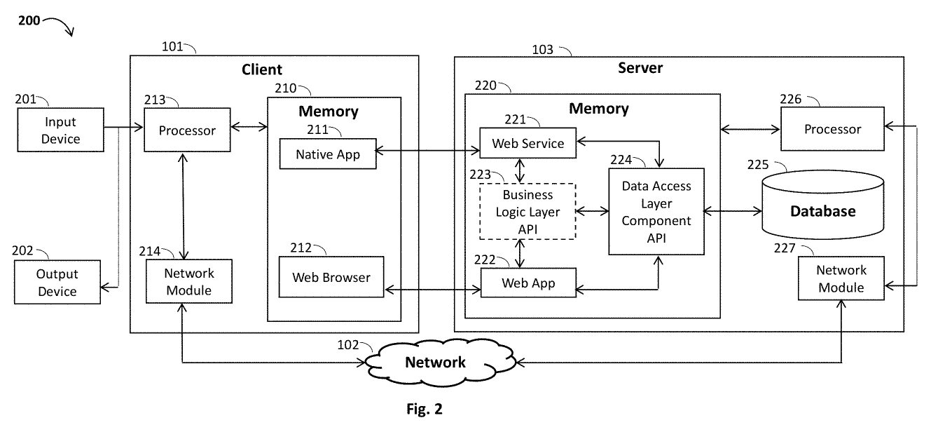

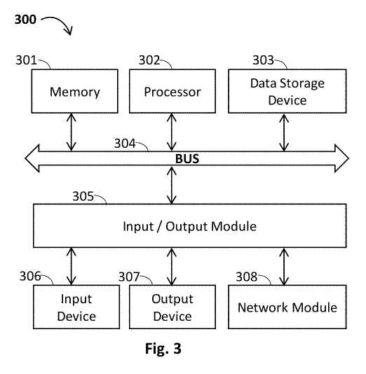

FIG. 1 illustrates an exemplary system architecture 100 includes client(s) 101, a network 102 and server(s) 103 wherein the server(s) and the client(s) are connected via network 102. Each client 101 is configured to install and run both a native application and a web browser that is used to run web application. Any application that does not use web browser is considered as native application, for example, windows desktop application, mac OS application, IOS application, android application, tablet application etc. The client 101 can be portable and non-portable. Clients can be, for example, desktop computers, laptop computers, mobile devices (such as smart phones, tablet, PDA), set top boxes, video game consoles, or any other devices having processor, memory and network and communication capabilities.

The web browser or native application installed on a client 101, is configured to load web pages or native application content from one or multiple servers 103 that host web application or server-side component of the native application. The server 103 can be any device having a processor, memory, network, communication capability to host the web application, server side component of the native application and able to store information into a database. By way of example, not limiting the scope of the invention, exemplary server can be any computer having an operating system (e.g. windows server), a web server (e.g. IIS) and a database (e.g. SQL Server). A skilled artisan would appreciate that in order to get performance gain, the database (e.g. SQL Server) can be installed on separate server different from the server that pays web server role. The network 102 can include, for example, any one or more of a personal area network (PAN), a local area network (LAN), a campus area network (CAN), a wide area network (WAN), a broad band network (BBN), metropolitan area network (MAN), the internet, and the like.

FIG. 2 is a block diagram 200 illustrating an exemplary server 103 and client 101 disclosed in the system architecture 100 in FIG. 1. The client 101 and server 103 are connected via network 102 using respective network module 214 and 227. The network modules 214 and 227 are configured to interface with network 102 to send and receive information to other devices on the network. The network modules 214 and 227 can be, for example, network interface cards (NIC), modems, Ethernet cards, network adapters or any devices that facilitate computer networking and send and receive information from one device to another device on the network.

Client 101 includes a processor 213, the network module 214, and a memory 210. The memory 210 includes a web browser 212 and a native application 21. The client 101 includes an output device 202 (e.g. display) through which content (i.e. client copy of a web application 222) of web browser and content of native application 211 are displayed. The client 101 includes an input device 201, for example, but not limited to, keyboard, mouse, stylus, touch screen or trackball.

Server 103 includes a processor 226, the network module 227, and a memory 220. The memory 220 includes a server side software that includes a web service 221, an optional business logic layer API 223, a data access layer component API 224 and a web application 222. The server includes a database (e.g. MS SQL Server, Oracle, Sybase, MySQL, PostgreSQL etc.) to store data required to execute instructions by the processor 226 of the server 103.

By way of example, not limiting the scope of the invention, in response to a request made by client 101 via web browser 212 to view list of donations received for a given year, the server 103 calls data access layer component API 224 to get the donation data from the database 225 and display the results within the web browser 212 of the client 101. By way of another example, in response to a request made by client 101 via web browser 212 to display a complex 990 tax return form for a given year, the server 103 calls business logic layer API 223, which then calls Data Access Layer Component API to get the required data and display results (i.e. 990 tax return form along with data from the database) within the web browser 212 of the client 101. A skilled artisan would appreciate that the database 225 which is shown in the server 103 can be installed on separate server (which is not shown) different from the server 103 that hosted web app 222, web service 221, business logic layer API 223 and Data Access Layer API 224 in order to have a performance gain and lessening the work load of the server 103.

The processor 213 of the client 101 is configured to execute instructions, such as instructions physically coded into the processor 213, instructions received from software (i.e. web browser 212, native application 211) in memory 210, or combination of both. For example, the processor 213 of the client 101 executes instructions from the web browser 212 to receive a request from a user using input device 201 to open an authentication page within the web browser wherein the request is sent to the server 103 via network 102. In response to the request, the processor 226 of the server 103 executes instructions, such as instructions physically coded into the processor 226, instructions received from the server side software in memory 220, or combination of both, and send response to the web browser 212 of the client 101 which is then displayed to the output device 202.

FIG. 3 is a block diagram illustrating an exemplary computer system 300 that can be used to implement client 101 and server 103 of FIG. 2. Computer system 300 (e.g. client 101 and server 103) includes a bus 304 or other communication means to communicate information, and a processor 302 (e.g. processor 213 and 226) which is coupled with bus 304 to process information. The processor 302 can be a general purpose microprocessor, a microcontroller, a Central Processing Unit (CPU), a Digital Signal Processor (DSP), an Application Specific Integrated Circuit (ASIC), a Programmable Logic Device (PLD), a field Programmable Gate Array (FPGA), a controller, a gated logic, discrete hardware components or any other component that can perform calculations or other manipulations of the information. Besides hardware, the computer system 300 can include one or more software or computer program, code that creates execution environment for the one or more software or computer program, a protocol stack, a database management system, an operating system, or a combination of one or more of them stored in an included memory 301 (e.g. memory 210 and 220 of FIG. 2). The memory 301 can be a Random Access Memory (RAM), a flash memory, a Read Only Memory (ROM), Programmable Read Only Memory (PROM), an Erasable PROM, registers, removable disk, a CD-ROM, a DVD, a hard disk or any other appropriate storage device configured to couple with bus 304 for storing instructions and information to be executed by the processor 302. The instructions stored in the memory 301 may be implemented as one or more computer program products, for example, one or more modules or components of computer program instructions encoded on a computer readable medium for execution by the computer system 300 using any method well known to a skilled artisan, including, but not limited to, computer languages such as data-oriented language (e.g. SQL), system languages (e.g. C, objective-C, C++, Assembly), application languages (e.g. Languages used in .NET framework, for example, C#, Java, Visual Basic, PHP, Perl, Ruby, Python. HTML). The memory 301 can also be used to store temporary variables or other intermediate information during execution of the instructions to be executed by the processor 302.

The computer system 300 includes a data storage device 303. The data storage device 303 includes one or more machine readable storage medium to store data, by way of example, a Hard Disk Drive (HDD), a Solid State Drive (SSD), an Optical Disk Drive (ODD), a flash drive, Tape, or a combination of one or more of them. The one or more machine readable storage medium excludes any forms of transmission medium such as a carrier wave.

The computer system 300 can be coupled to multiple devices, such as an input device 306 (e.g. element 201 of FIG. 2), and/or an output device 307 (e.g. element 202 of FIG. 2) using Input/Output Module 305. The exemplary input/output module 305 includes data ports such as USB ports or the like. The exemplary input device 306 includes, for example, but not limited to, keyboard, mouse, stylus, touch screen or trackball by which user can provide input to the computer system 300. Other kinds of input device can also be used, such as tactile input device, visual input device, audio input device. By way of example, feedback provided to the user can be any form of sensory feedback, e.g., visual feedback, auditory feedback, or tactile feedback and input from the user can be received in any form including tactile, acoustic or speech. Exemplary output device 307 includes display devices, for example, but not limited to, a Liquid Crystal Display (LCD) monitor, a Cathode Ray Tube (CRT) monitor, a touch sensitive display or any device that is configured to display information to the user.

The input/output module 305 is further configured to connect to a network module 308 (e.g. element 214 and 227 of FIG. 2) which includes a network interface cards (NIC), modems, Ethernet cards, network adapters or any devices that facilitate computer networking and send and receive information from one device to another device on the network.

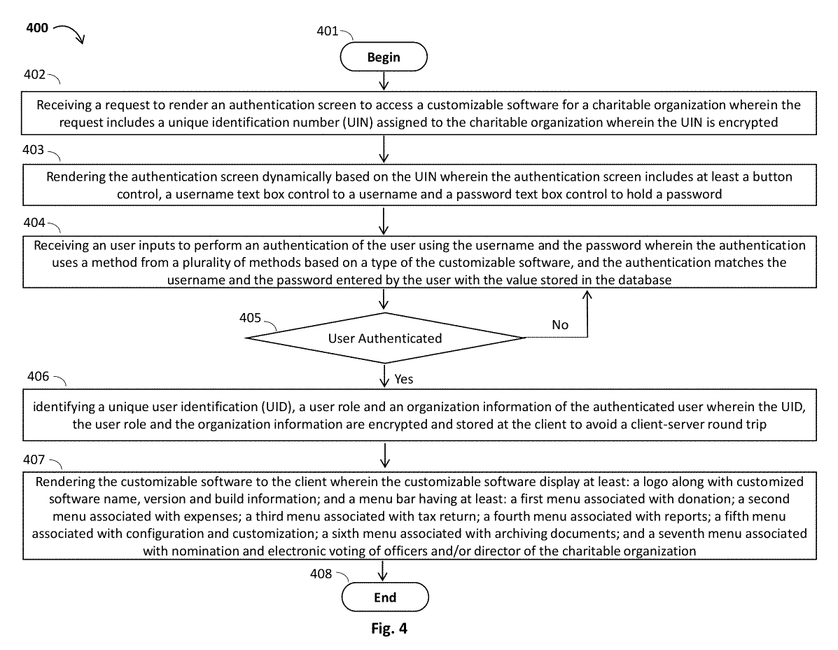

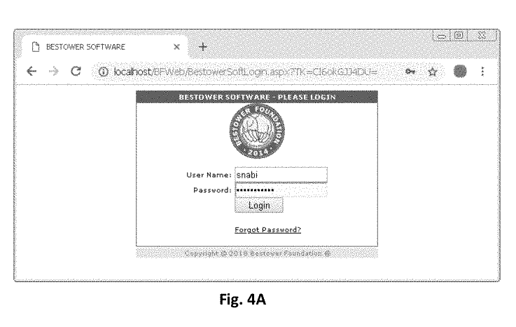

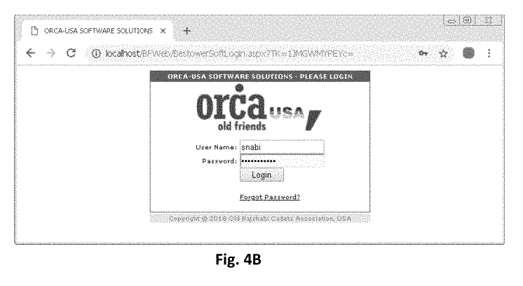

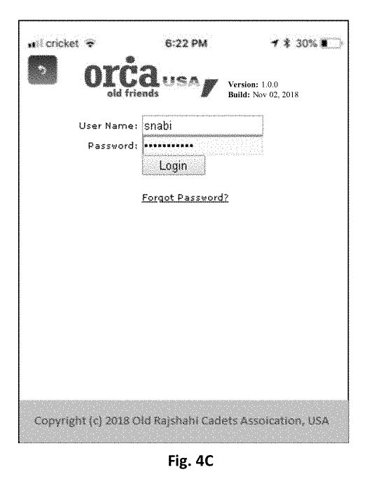

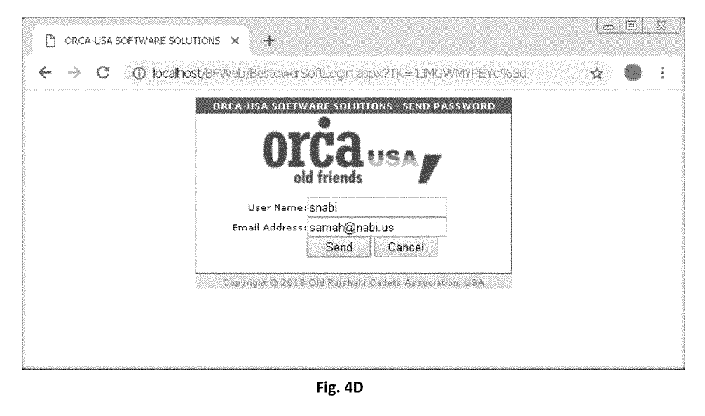

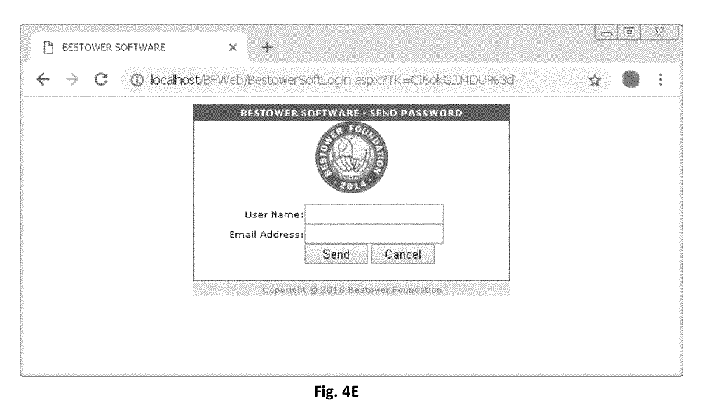

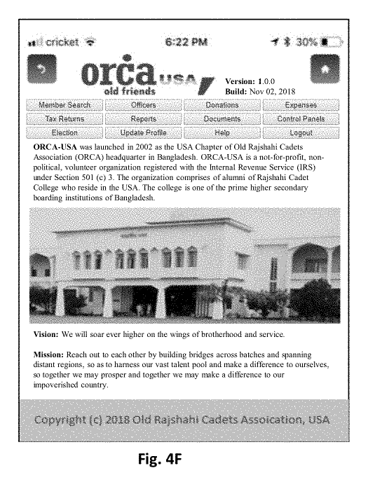

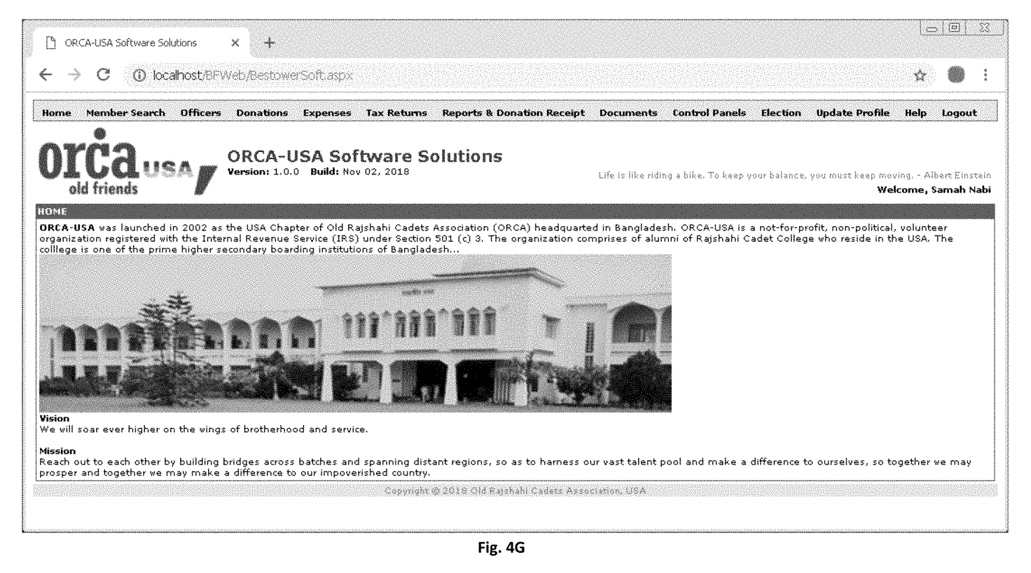

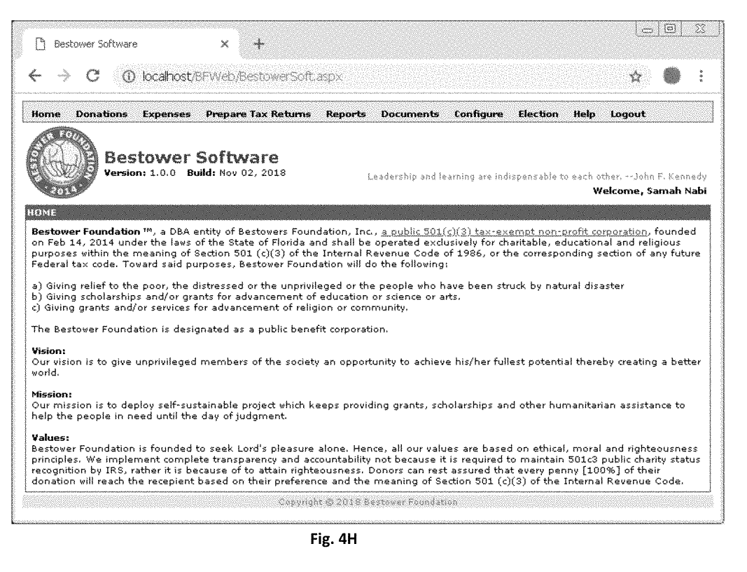

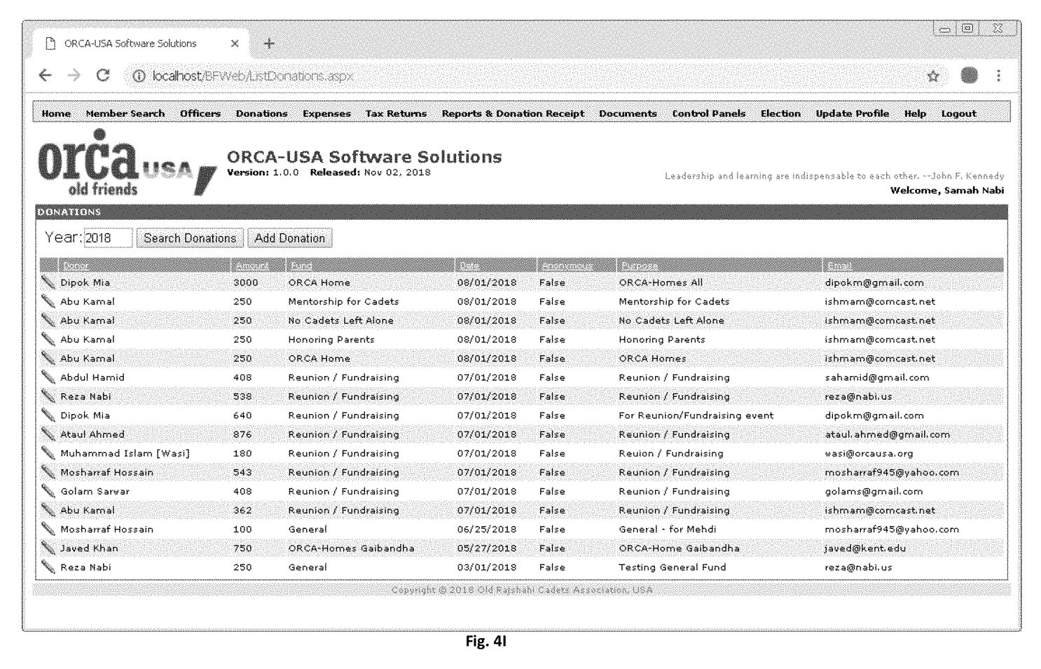

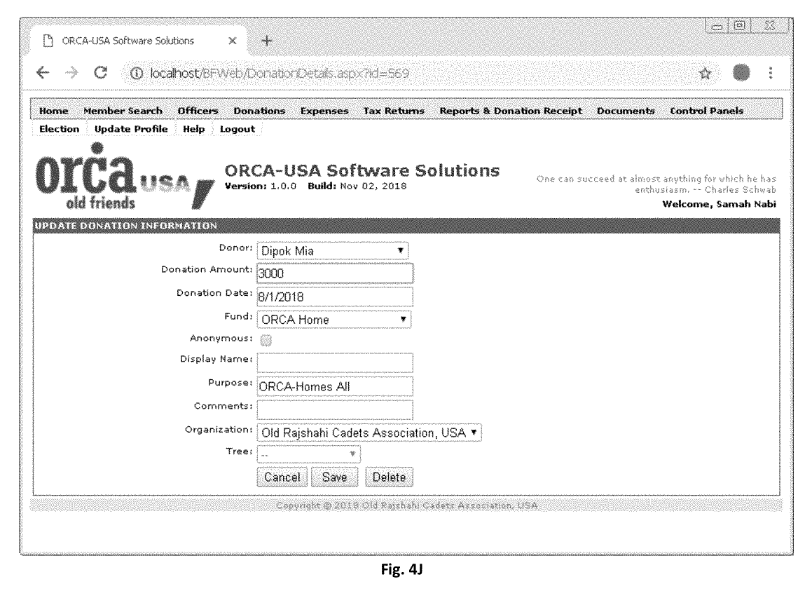

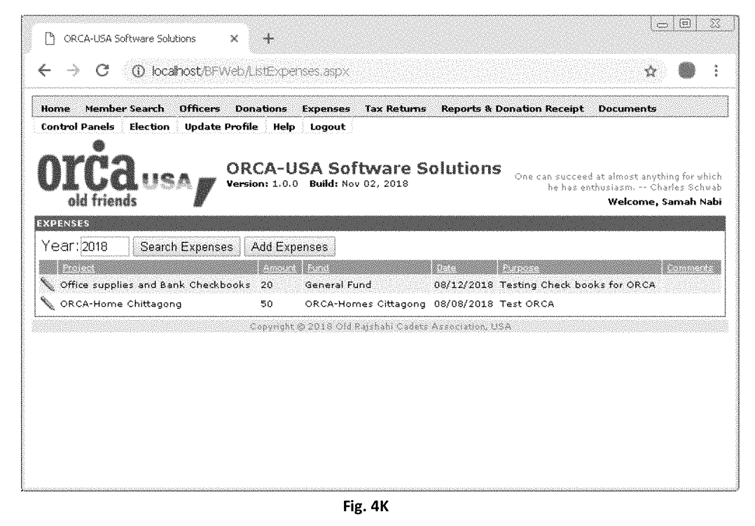

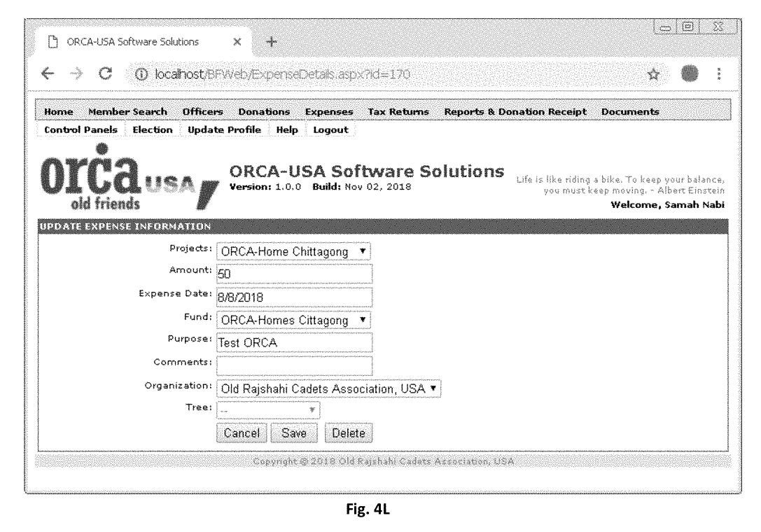

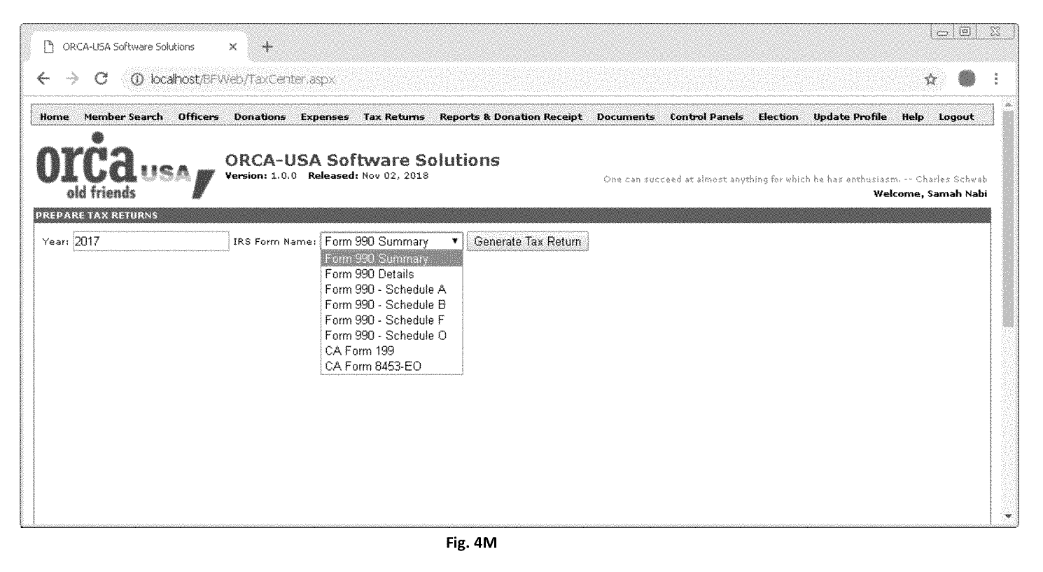

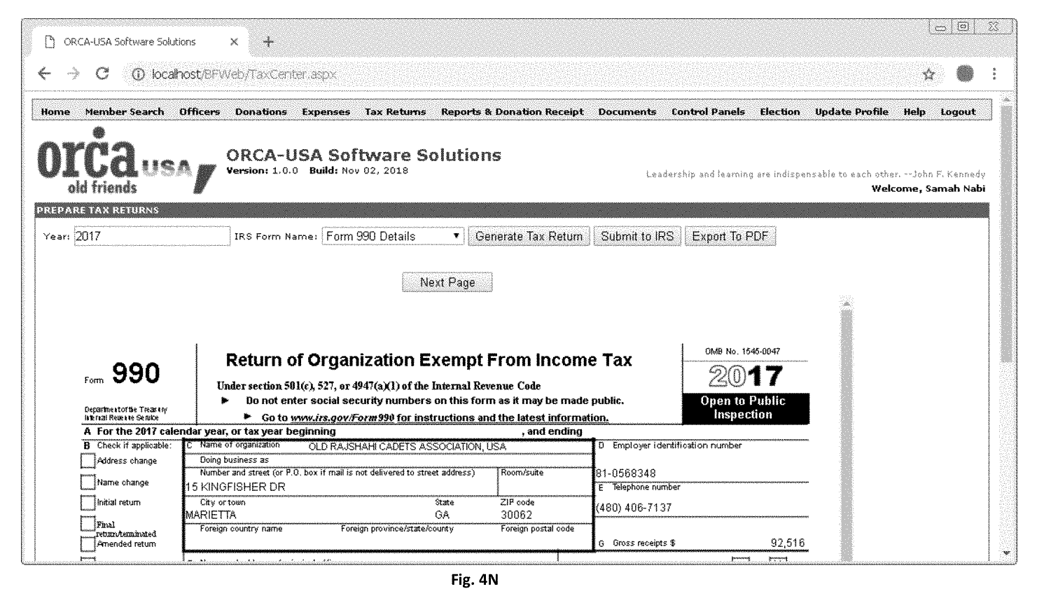

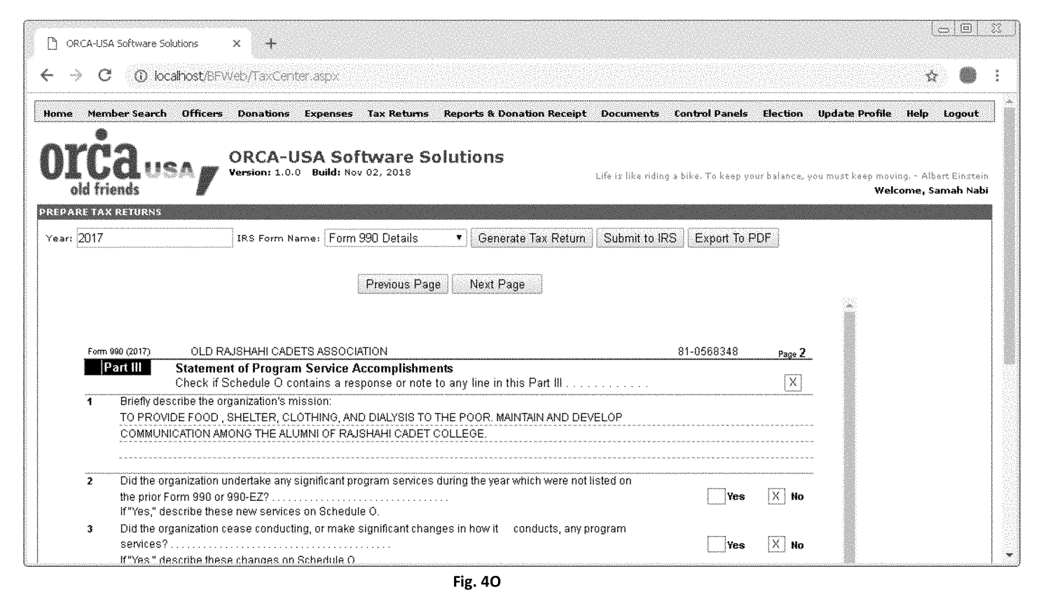

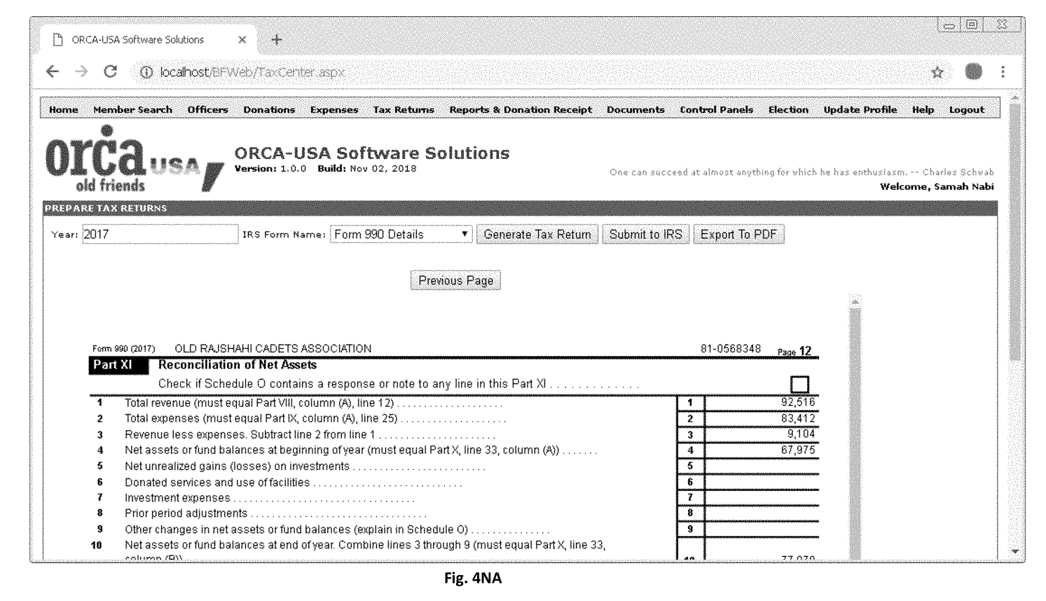

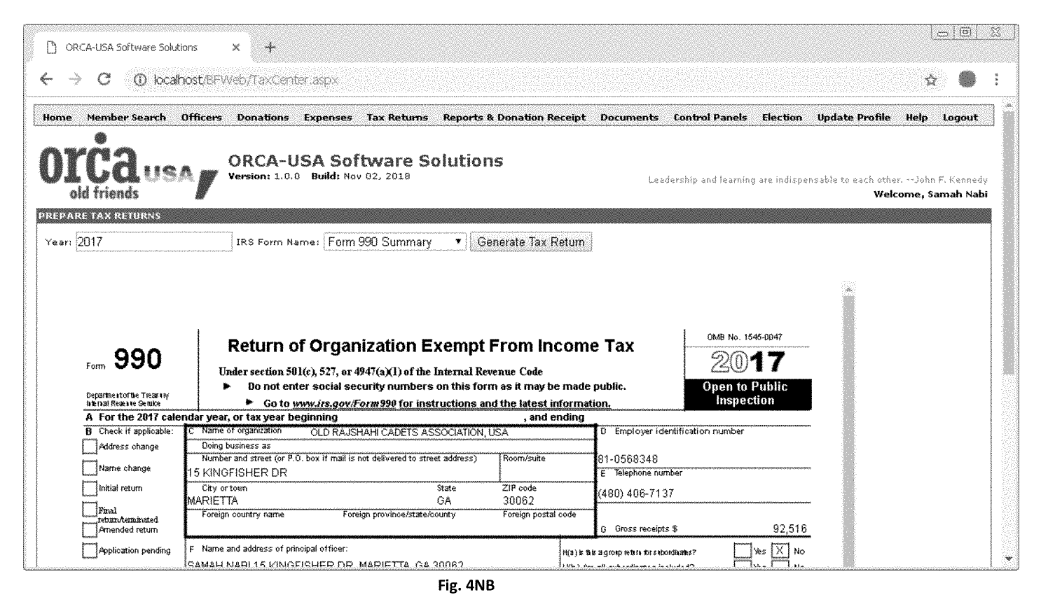

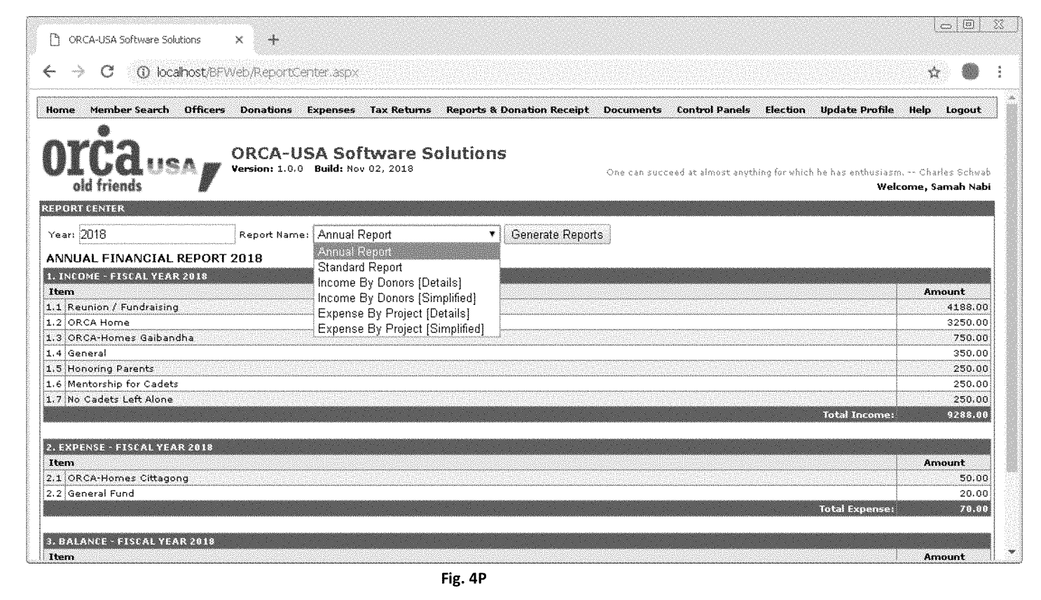

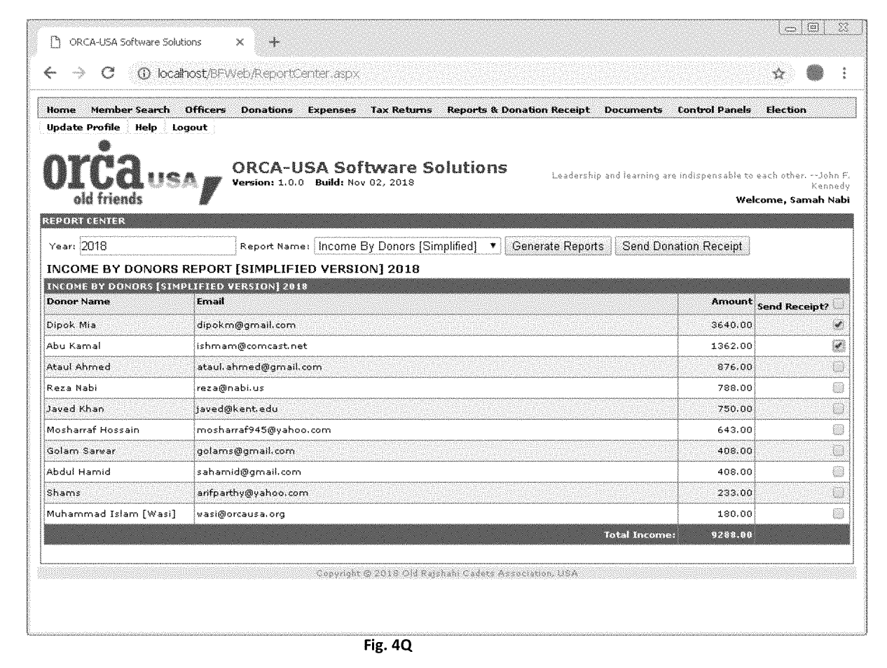

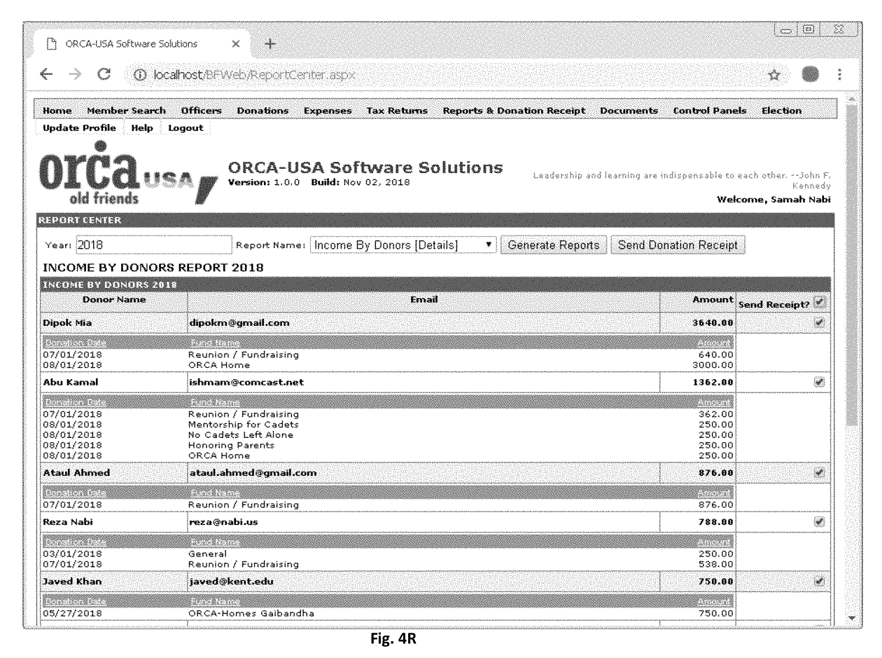

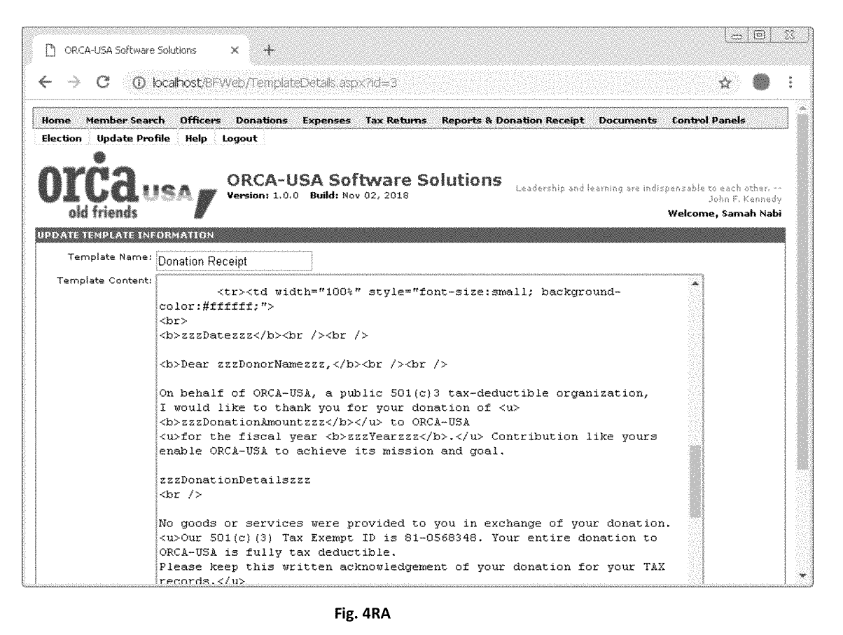

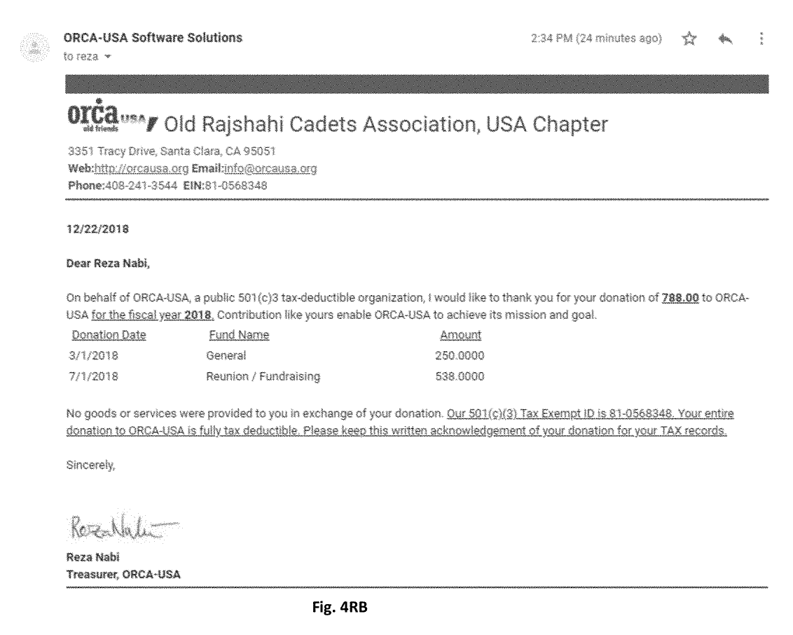

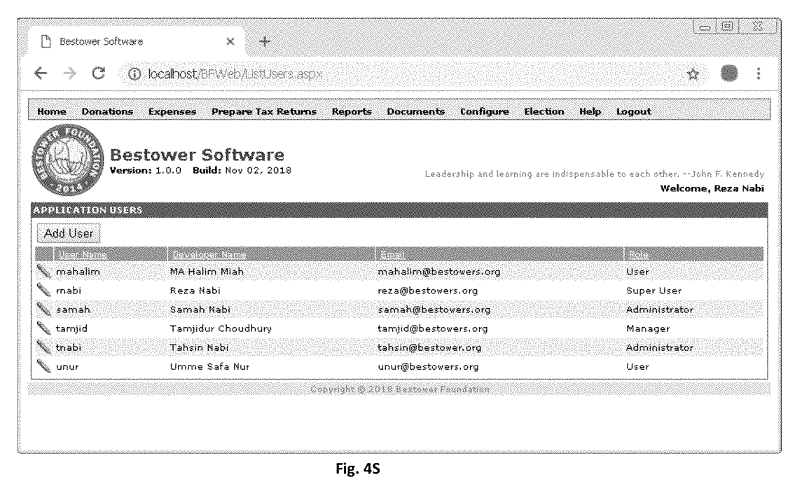

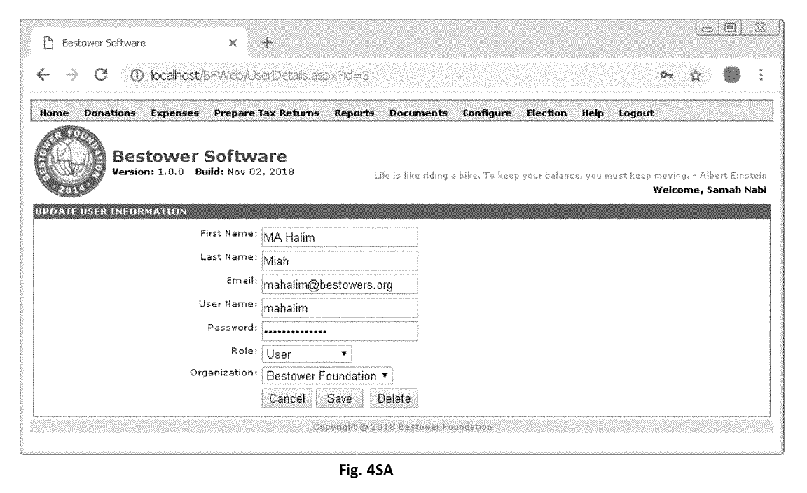

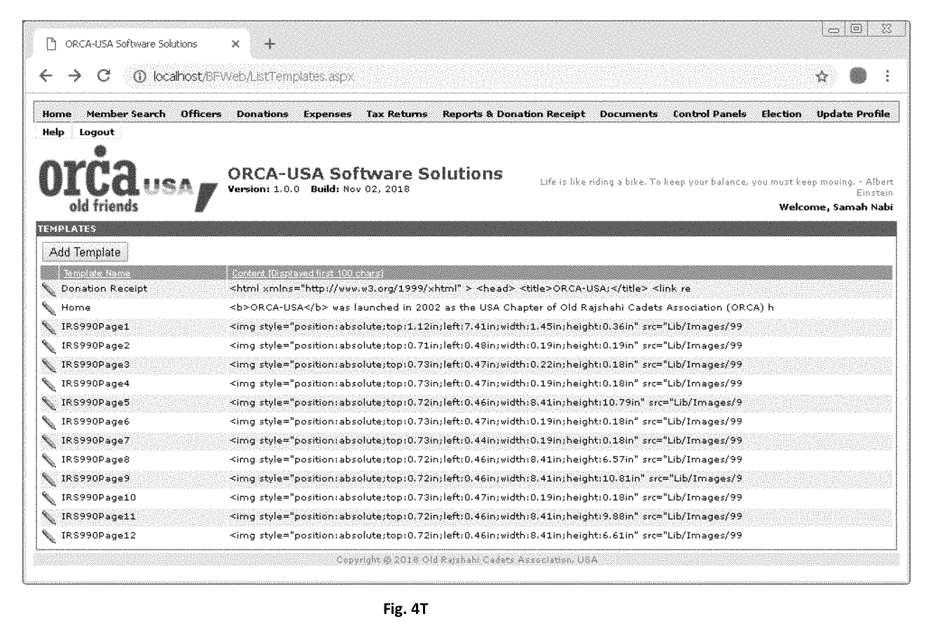

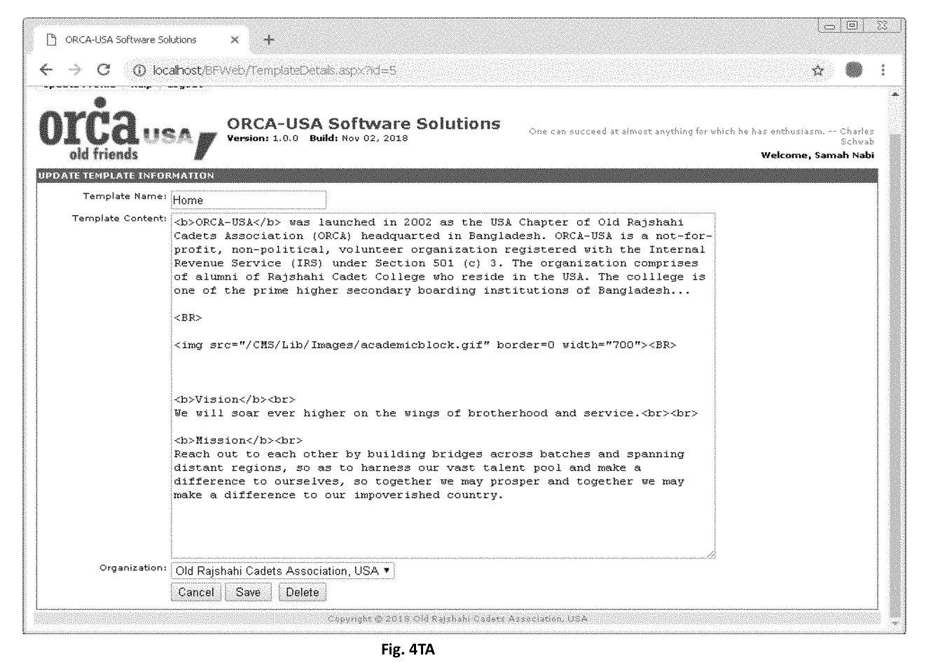

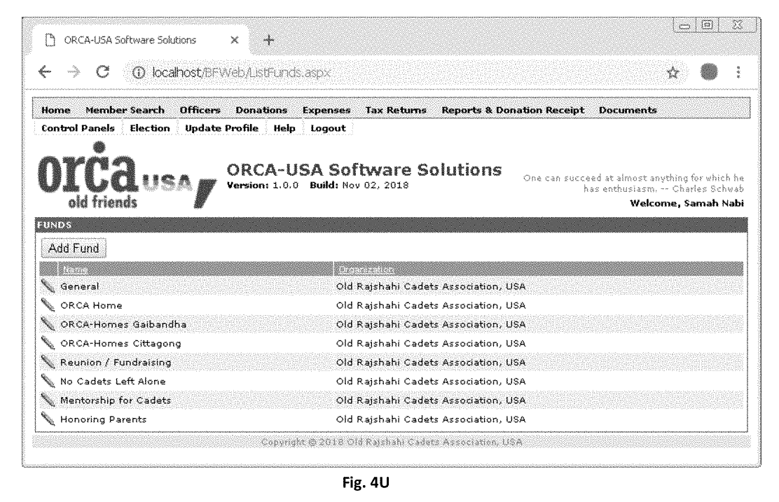

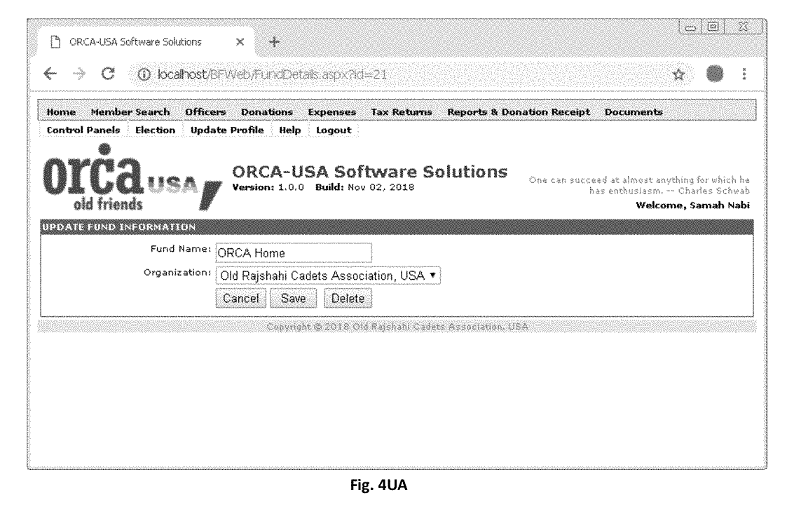

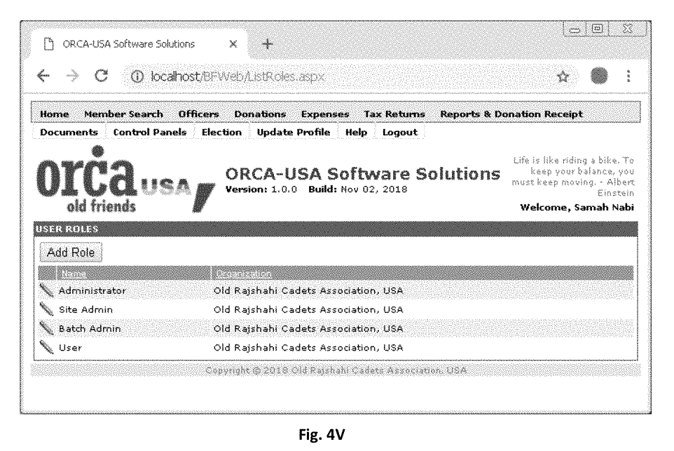

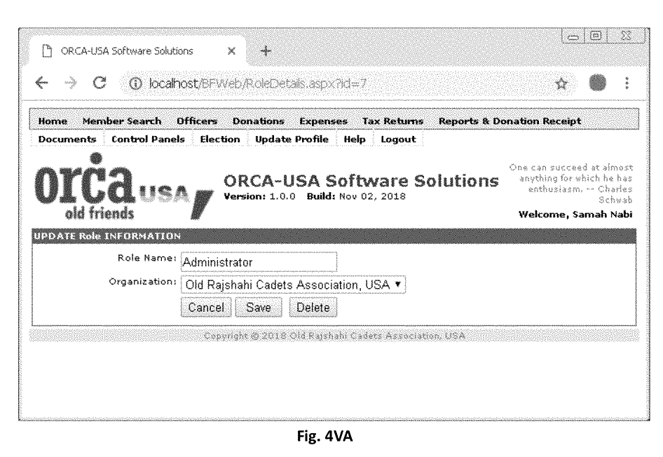

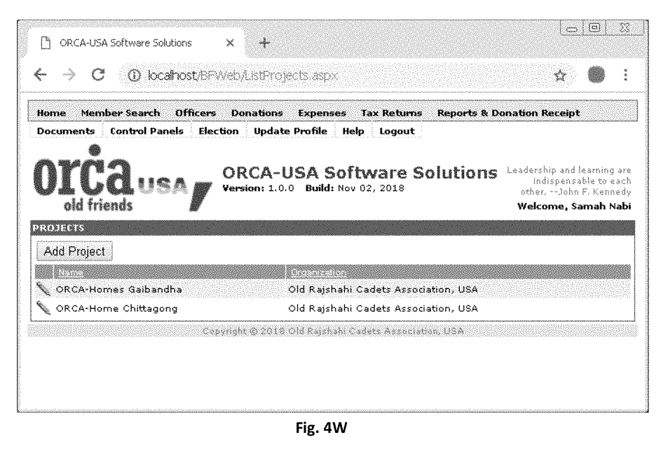

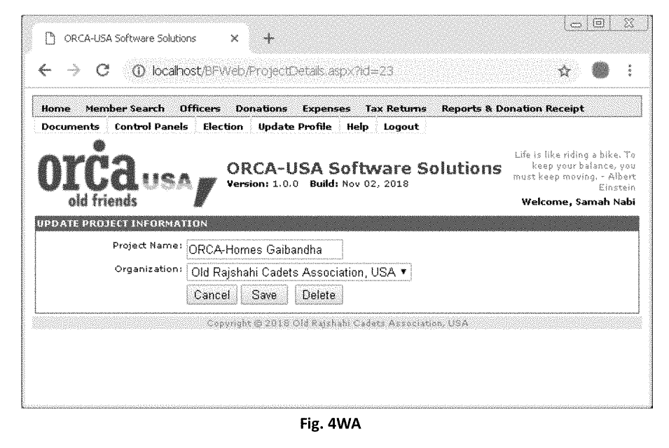

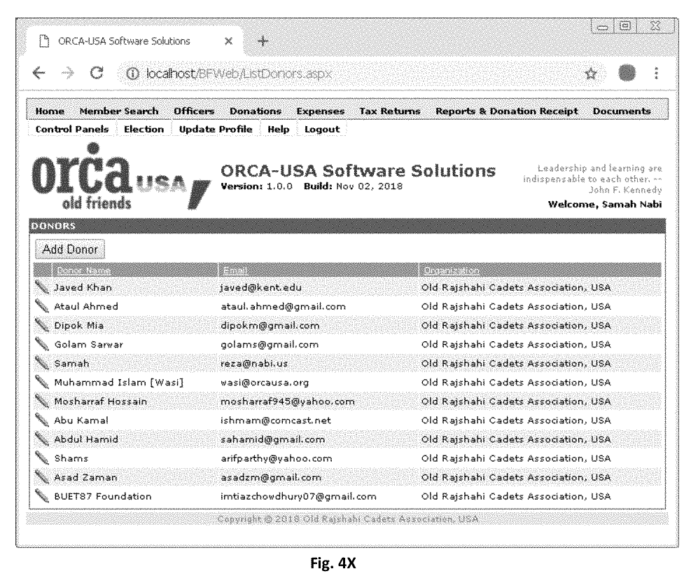

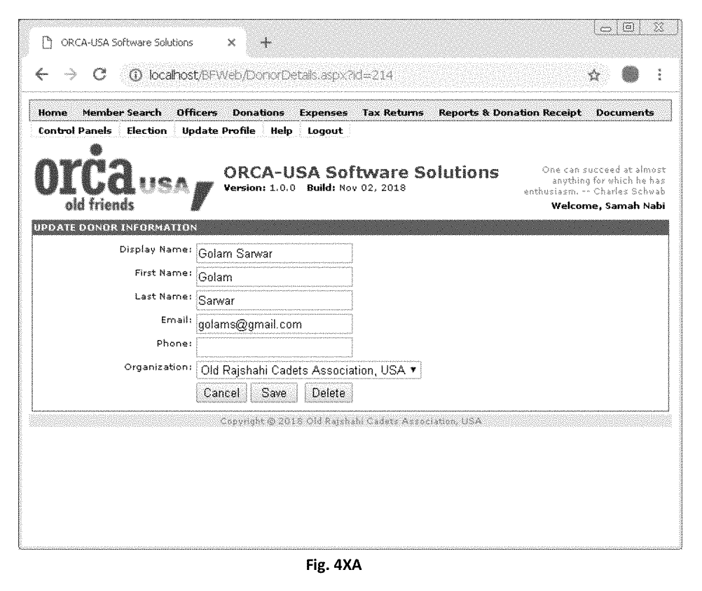

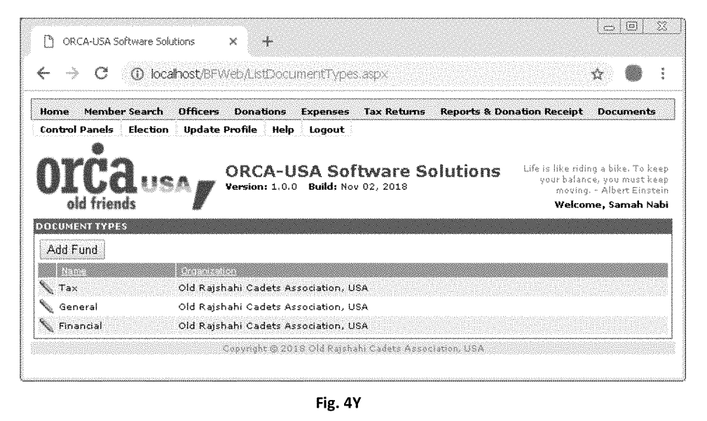

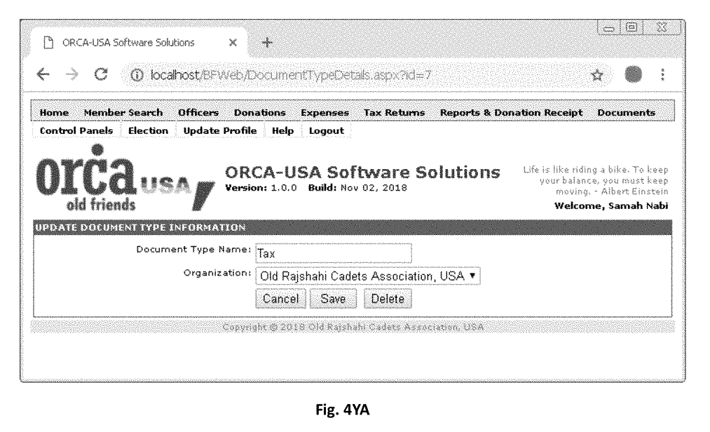

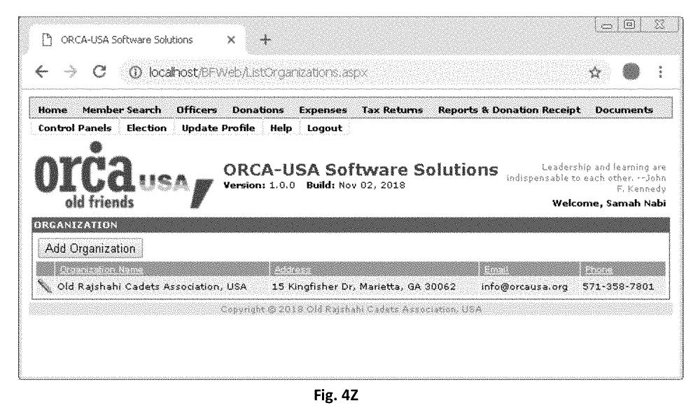

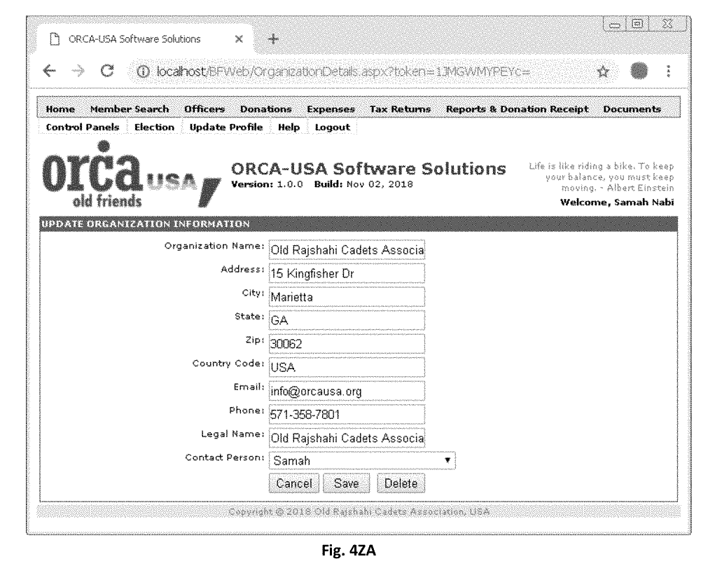

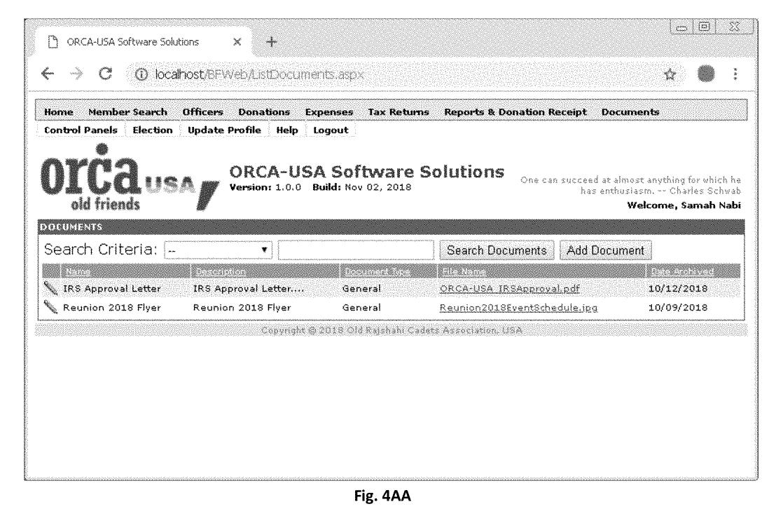

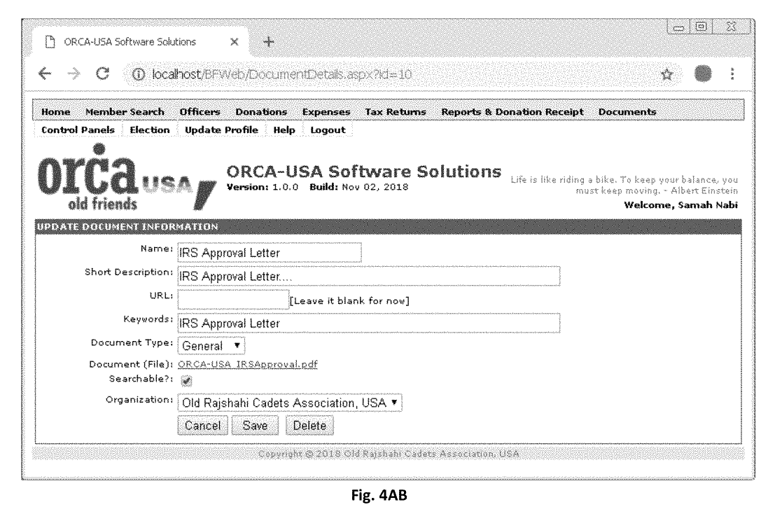

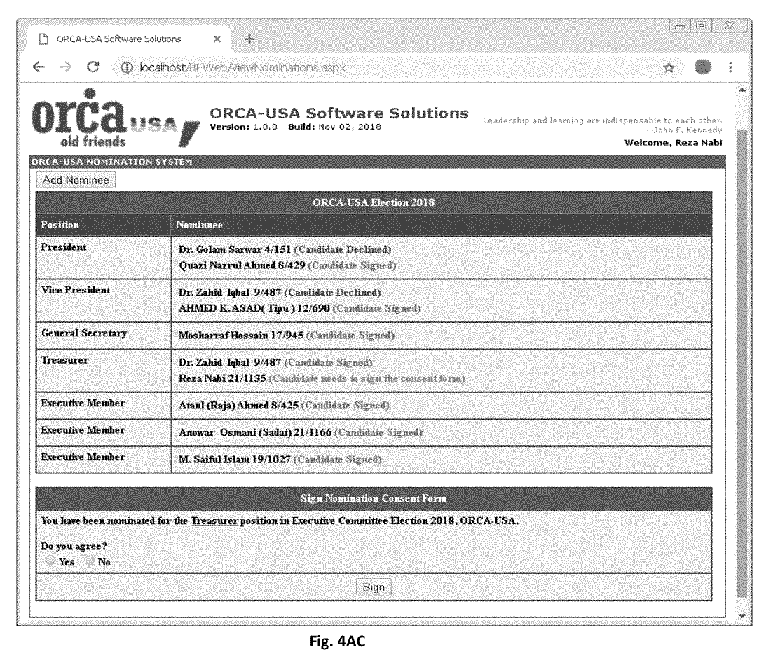

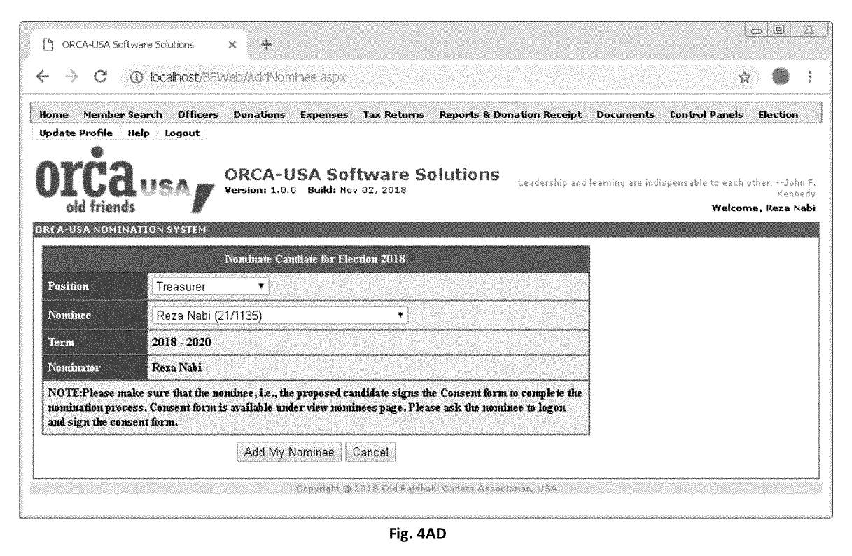

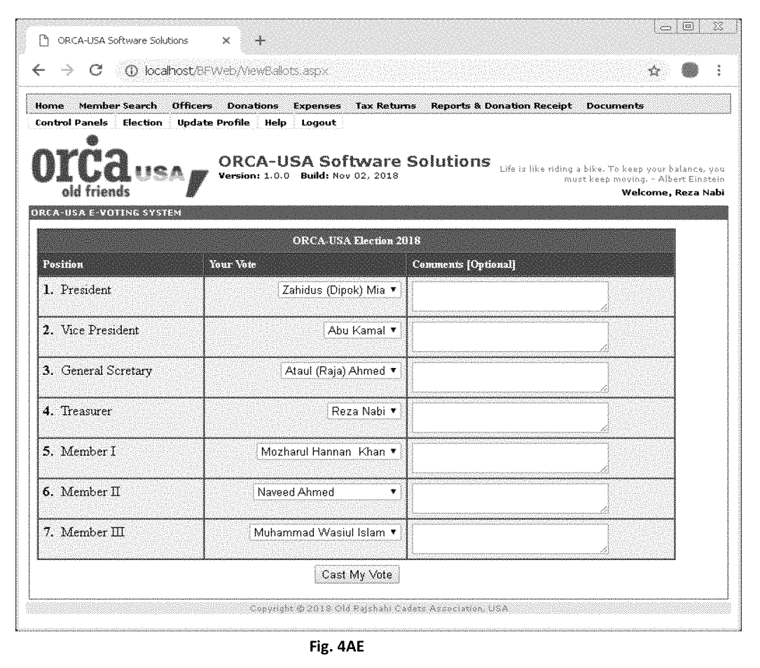

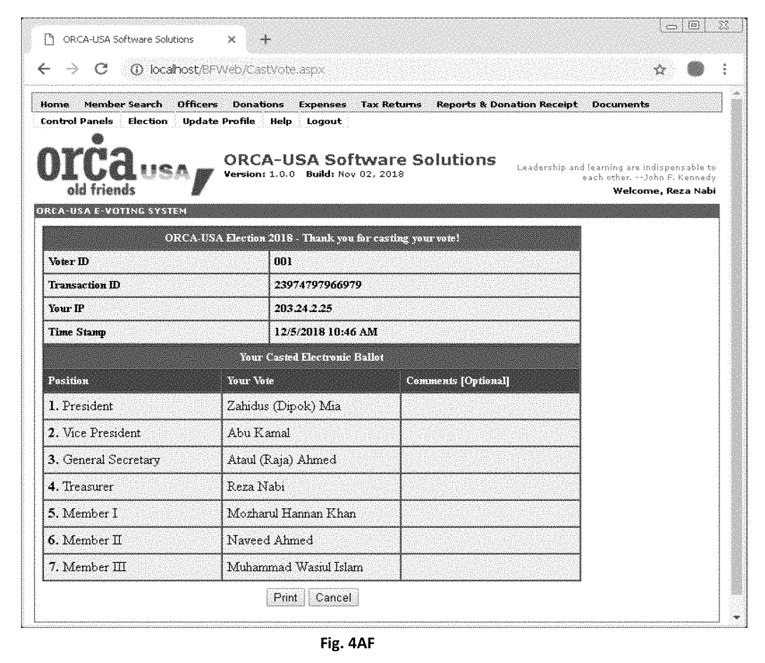

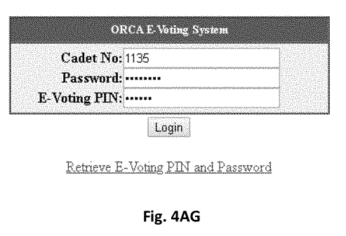

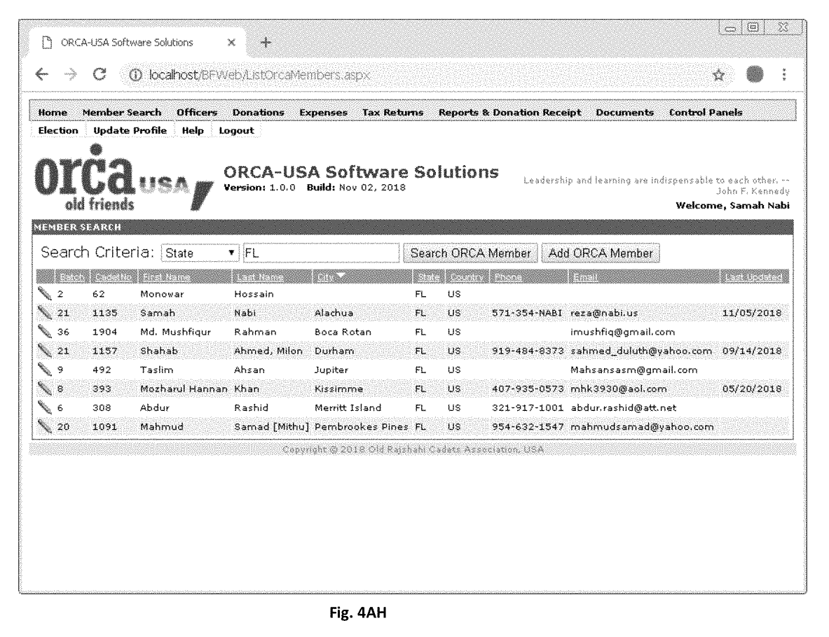

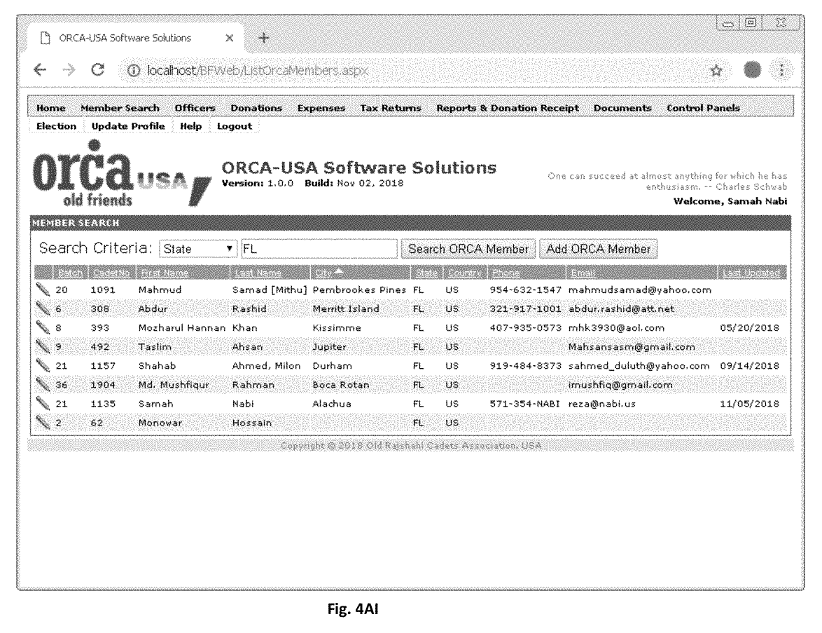

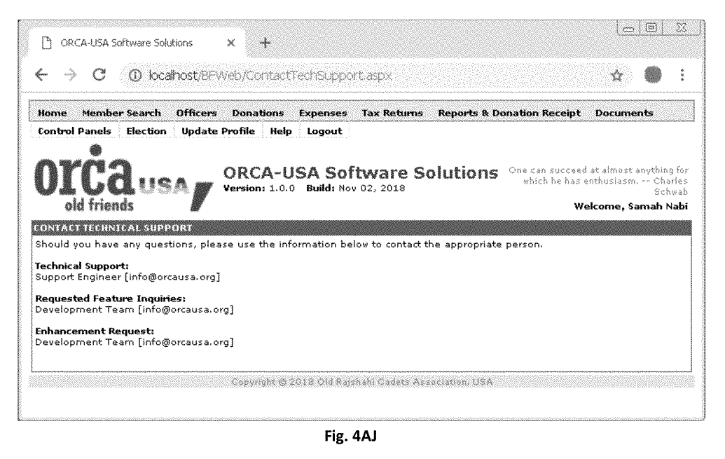

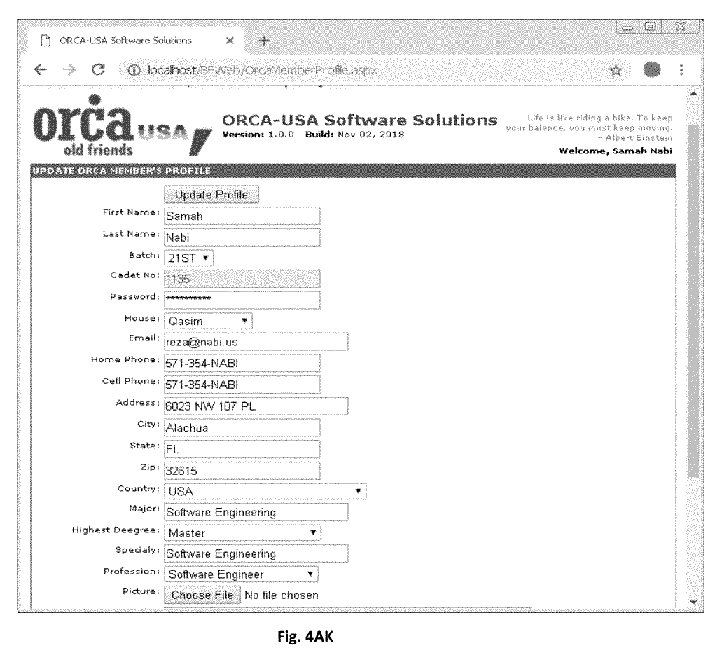

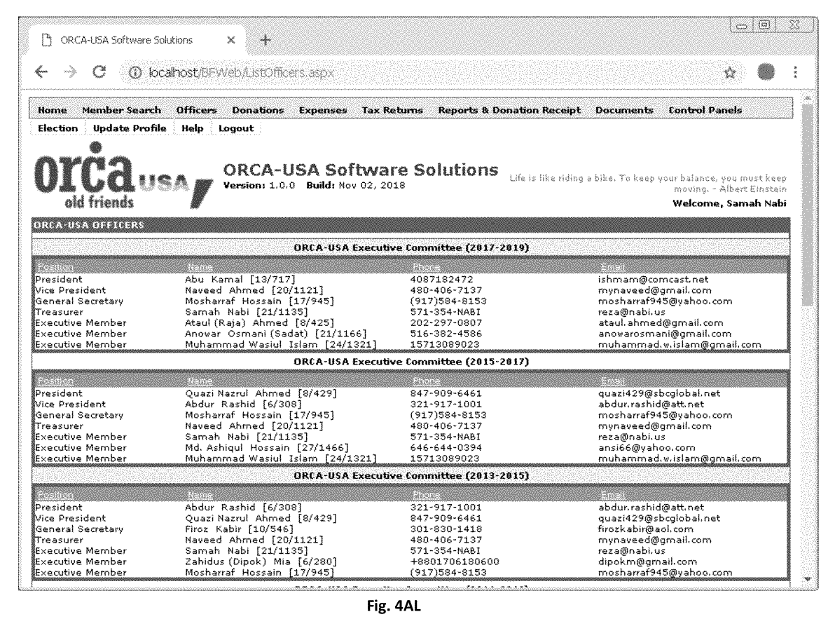

FIG. 4 is an exemplary process of 400 for providing a customizable software for a charitable organization to perform a plurality of required activities to stay compliant with federal, state and Internal Revenue Service (IRS) regulations using exemplary client 101 and server 103 of FIG. 2. The process begins by proceeding from step 401 when a user opens a web browser to step 402 when the client 101 sends a request to the server 103 to render an authentication screen within the web browser to access the customizable software. In one embodiment, the request sent to the server can be in form of uniform resource location (URL) wherein the URL includes a unique identification number (UIN) assigned to the charitable organization. The UIN is passed in to the URL as a Query String, wherein the entire Query String is encrypted. For example, if a charitable organization is assigned UIN “0001”, plain text URL without any encryption may look like, “http://localhost/BesowerSoftLogin.aspx?orgid=00001”, wherein “orgid=00001” is a Query String (i.e. “orgid” is key and “0001” is value, the UIN). In order to decrease the security threat, the present invention sends the request to the server with the entire query string (i.e. both key and value) encrypted. Exemplary request URL with the entire query string encrypted looks like http://localhost/BestowerSoftLogin.aspx?ha=KTy=U%Zuzd12zhzd= wherein “ha=KTy=U%Zuzd12zhzd=” is the encrypted query string which contains both key and value [i.e. UIN] of the query string.

In step 403, upon receiving the request from the client 101, the server 103 decrypts the entire query string and parse it to identify the UIN (i.e. passed in value of the query string). The server 103 render a customized authentication screen based on the matched UIN to the client 101 wherein the customized authentication includes at least a logo representing the charitable organization, a button control, a user name text box control to hold user name, and a password text box control to hold a password. FIG. 4A and FIG. 4B illustrates an exemplary screenshot of the web browser 212 that sent a request to the server 103 and the server 103 rendered the customized authentication screen to the client 101 based on the encrypted UIN which is passed as query string. FIG. 4A illustrates a customized authentication screen of Bestower Foundation, a charitable organization, and FIG. 4B illustrates a customized authentication screen of ORCA-USA, another charitable organization. FIG. 4C illustrates another customized authentication screen for native application 211. In one embodiment, the customized authentication screen may include a link (i.e. “forgot password?”) to retrieve password. In response to selecting the “forgot password” link, the server 103 renders a forgot password screen. In one embodiment the forgot password screen may include username, email address and a button control to retrieved password in real time wherein the password is sent to user's email address matched in the database. FIG. 4D-4E illustrate an exemplary forgot password screen which is rendered by the server 103 to the web browser 212 in client 101 (FIG. 4D for one charitable organization, ORCA-USA and FIG. 4E for another charitable organization, Bestower Foundation).

In step 404, an authentication is performed by the server 103 using user inputs (e.g. username and password) entered into the authentication screen in response to clicking on the button control (e.g. login button). The user is authenticated when username (that is entered by the user), password (that is entered by the user) and the UIN (that is passed in as encrypted query string) matches with the database. The authentication is performed using a method from a plurality of methods. In one embodiment, when the customized software is a web application 212, the server 103 perform authentication using Non-Web Service method (e.g. ADO.NET) to check if the username, the password and the UIN matches with the database. In another embodiment, when the customized software is a native application 211, the authentication uses Web Service method to check if the username, the password, and the UIN matches the database. In one embodiment, both username and password is stored in the database as encrypted using an encryption algorithm. In another embodiment, username is stored in the database as plain text and password is stored in the database as encrypted using an encryption algorithm. The exemplary encryption algorithm can be used to encrypt the username and/or password, for example, but not limited to. Triple DES, RSA, Blowfish. Twofish or AES.

When authentication fails, the user is sent back to the authentication screen along with error message. In step 406, upon successful authentication, the server 103 identifying a unique user identification (UID), a user role and an organization information of the authenticated user wherein the UID, the user role and the organization information are encrypted and stored at the client to avoid a client-server round trip. In one embodiment, upon having a successful authentication, the server 103 identify at least authenticated user's user identification (UID), user's role (e.g. roleid of the user) and user's organization information (e.g. organization id, organization's legal name, organization's logo, organization's preferred software name etc.) and concatenate the UID, the roleid and the organization information into a single string using a delimiter character (e.g. ‘;’ or ‘:’ etc.). The single string then encrypted and stored at the client 101. In one embodiment, the encrypted string at the client is stored as configuration file (e.g. text file, registry file or the like) which is used for native application 211. In one embodiment, the encrypted string at the client is stored as cookie in the web browser for web application 222. Storing crucial and frequently used values (such as UID, roleid and organization's information) at the client 101 (e.g. either as configuration file or cookie in the browser 212) would make the customized software faster. This is because getting information from client locally is faster than getting information from a server accessing backend database avoiding a client-server round trip.

After successfully store crucial and frequently used values at the client (e.g. storing into the cookie of the web browser for the web application 222 or storing into configuration file for native application 211), in step 407, the server renders the customized software to the client based on the identified UID, the user role and the organization information of the authenticated user. The customized software may include at least, but not limited to, a logo along with customized software name, version and/or the build information, a menu bar that includes at least, but not limited to, a first menu associated with donation, a second menu associated with expense, a third menu associated with tax return, a fourth menu associated with reports, a fifth menu associated with configuration and customization, a sixth menu associated with archiving documents, and a seventh menu associated with nomination and e-voting of officers and/or directors of the charitable organization. FIG. 4F-4H illustrate an exemplary screenshot of the customized software upon having a successful authentication. FIG. 4F illustrates customized software rendered within native application 211 (e.g. iPhone application run on mobile device running IOS) of client 101. FIG. 4G-4H illustrate customized software rendered within web browser 212 of client 101 for two different charitable organization. FIG. 4G display ORCA-USA Software solutions for ORCA-USA, a charitable organization and FIG. 4H display Bestower Software for Bestower Foundation, another charitable organization. The process 400 then ends in step 408.

With reference to the first menu associated with donation, FIG. 4I illustrates plurality of activities related with donation. The plurality activities displayed in FIG. 4I are search donations by any given parameter (e.g. donation year), display a donation search results wherein the search results are sortable in both ascending and descending order upon clicking on a column name (e.g. donor, amount, fund, date, purpose etc) of the search results table. In FIG. 4I, donations for the year 2018 are displayed upon clicking on ‘Search Donation’ button wherein 2018 is the given parameter entered by the user. In another embodiment, donations can be searched by other parameters such as, but not limited to, donor's name, donation amount, donation fund, donation's date and donation purpose. FIG. 4I displays an edit item icon (e.g. pencil icon, left most column of the donation search results table, next to donor's name) which allows user to view details of the selected donation and edit the selected donation which is shown in FIG. 4J. In the edit donation page in FIG. 4J, user is able to update the donation by clicking on ‘Save’ button and by clicking on ‘Delete’ button user is able to delete the selected donation. It should be noted that the delete button is displayed only for those users who has administrative privilege. Clicking on ‘Cancel’ button of FIG. 4J cancels the edit donation activities and returns back to donations page (i.e. FIG. 4I). FIG. 4I also displays an “add donation” button which facilitate user to add donation and after adding a new donation, it returns back to the donation page displayed in FIG. 4I.

With reference to the second menu associated with expense, FIG. 4K illustrates plurality of activities related with expense. The plurality activities displayed in FIG. 4K are search expenses by any given parameter (e.g. expense year), display an expense search results wherein the search results are sortable in both ascending and descending order upon clicking on a column name (e.g. project, amount, fund, date, purpose etc) of the search results table. In FIG. 4K, expenses for the year 2018 are displayed upon clicking on ‘Search Expenses’ button wherein 2018 is the given parameter entered by the user. In another embodiment, expenses can be searched by other parameters such as, but not limited to, project's name, expense amount, fund, expense date and expense purpose. FIG. 4K displays an edit item icon (e.g. pencil icon, left most column of the expense search results table, next to project's name) which allows user to view details of the selected expense and edit the selected expense which is shown in FIG. 4L. In the edit expense page illustrated in FIG. 4L, user is able to update the expense by clicking on ‘Save’ button and by clicking on ‘Delete’ button user is able to delete the selected expense. It should be noted that the delete button is displayed only for those users who has administrative privilege. Clicking on ‘Cancel’ button of FIG. 4L cancels the edit expense activity and returns back to expenses page (i.e. FIG. 4K). FIG. 4K also displays an “add expenses” button which facilitate user to add expense and after adding a new expense, it returns back to the expense page illustrated in FIG. 4K.

With reference to the third menu associated with preparing and filing tax return to Internal Revenue Service (IRS), FIG. 4M illustrates plurality of activities related with preparing and filing tax return to IRS. The plurality activities illustrated in FIG. 4M are search and generate a tax return form for any given parameter (e.g. fiscal year or any other parameter based on the organization's requirement) and file the tax return form dynamically based on data stored in the database provided the IRS is ready accept the tax return form. FIG. 4M displays a text box to enter a parameter, e.g. fiscal year and an IRS Form Name drop down box having plurality of IRS Form names, such as IRS Form 990, other forms required by state (e.g. CA Form 199, CA Form 8453-EO which is required by California state where the ORCA-USA charitable organization is registered), based on the charitable organization's registered state and requirement to stay compliant IRS guidelines. FIG. 4M displays a “Generate Tax Return” button and in response to clicking on the “Generate Tax Return” button, it searches all data based on the selected parameter (i.e. Year and IRS Form Name) and generate Tax return form, which is illustrated in FIG. 4N wherein page 1 of 990 form is displayed for fiscal year 2017. FIG. 4N facilitate user to verify if generated form 990 is correct by navigating pages of 990 form by clicking on ‘Next Page’ button which results in displaying page 2 of 990 form wherein a new ‘Previous Page’ button is displayed, that is illustrated in FIG. 4O. The ‘Previous Page’ button facilitate user to go back to previous page. In one embodiment, when the first page (e.g. page 1 of 12) of the 990 form is displayed to the user, only ‘Next Page’ button is rendered hiding the “Previous Page” button (illustrated in FIG. 4N) and when the last page (e.g. page 12 of 12) of the 990 form is displayed to the user, only ‘Previous Page’ button is rendered hiding the “Next Page” button (illustrated in FIG. 4NA). In another embodiment, when a single page is returned to the user, both “Previous Page” and “Next Page” button is not displayed, which is illustrated in FIG. 4NB, showing single page 99) Summary page. In addition, in FIG. 4NB, since 990 summary only display part of the 990 form (i.e. summary page), the additional features (e.g. “Submit to IRS” button to file 990 electronically to IRS) to submit the 990 to IRS is removed.

In one embodiment, upon successful generation of the selected IRS form (e.g. Form 990) in response to clicking on ‘Generate Tax Return’ button, as illustrated in FIG. 4N, two additional buttons (e.g. ‘Submit to IRS’ and ‘Export to PDF’) are displayed. The ‘Submit to IRS’ button displayed in FIG. 4N facilitate user to submit (or file) the generated IRS form (e.g. Form 990) electronically to IRS provided the IRS is ready accept the tax return for the selected fiscal year. This helps the charitable organization stay compliant federal regulations and maintain the charitable organization's tax-exemption status associated with, for example, section 501 (c)(3) of the Internal Revenue Code. The button ‘Export to PDF’ facilitate user to export the generated IRS tax return form (e.g. Form 990) as a PDF file which user can print, sign and mail to IRS.

With reference to the fourth menu associated with generating various customizable reports, FIG. 4P illustrates plurality of activities related with generating various customizable reports. The plurality activities illustrated in FIG. 4P are generating a report dynamically from a plurality of reports based on a given report parameter, wherein the plurality of reports include at least annual report, standard report, and income by donors, and expense by projects. FIG. 4P displays a text box to enter a parameter, e.g. fiscal year and a report name drop down box having plurality of report names, such as, but not limited to, annual report, income by donors, expense by project based on the charitable organization's requirement. FIG. 4Q displays a “Generate Reports” button and in response to clicking on the “Generate Reports” button, it searches all data stored in database (225 of FIG. 2) based on the selected parameter (i.e. Year and Report Name) and generate report, which is illustrated in FIG. 4P wherein annual report is displayed for fiscal year 2018.

In one embodiment, the user is able to generate income by donors (simplified version) report based on the given parameter (e.g. fiscal year) which is illustrated in FIG. 4Q. In another embodiment, income by donors (details version) report based on given parameter (e.g. fiscal year) which is illustrated in FIG. 4R. In one embodiment, upon successful generation of the selected “income by donors (simplified)” in response to clicking on ‘Generate Reports’ button, as illustrated in FIG. 4Q, an additional button (e.g. ‘Send Donation Receipt’) is displayed. The ‘Send Donation Receipt’ button facilitate user to send donation receipts to all donors which are checked or selected in single click. Content of the donation receipts is template based wherein the template is configurable by user and donor's name, donation information is dynamically plugged in to the template and send the donation receipt to donor(s) via email stored in the database (225 of FIG. 2). FIG. 4RA illustrates a donation receipt template wherein plurality of variables (e.g. zzzDatezzz, zzzDonorNamezzz, zzzDonationAmountzzz, zzzYearzzz, zzzDonationDetailszzl, zzCompanyNamezzz, zzzOffierNamezrz, zzeOfficerSignaturezzz etc but not limited to) are used to plugin related values dynamically. The donation receipt templates are stored in the database (225 of FIG. 2) and configurable by the charitable organization. FIG. 4RB illustrates an exemplary donation receipt content which is generated dynamically based on the donation receipt template replacing variables with the values retrieved from the database 225 and send to donor via email.

In one embodiment, the income by donors report displays a check box (e.g. “Send Receipt?” in FIG. 4Q) which allows user to select or unselect all check boxes in single click.

In one embodiment, upon successful generation of the selected “income by donors (details)” in response to clicking on the ‘Generate Reports’ button, as illustrated in FIG. 4R, an additional button (e.g. ‘Send Donation Receipt’) is displayed. The ‘Send Donation Receipt’ button facilitates users to send donation receipts to all donors which are checked or selected in single click. It should be noted that “income by donors (details)” displays all donations in details but “income by donors (simplified)” display donation information hiding the details of plurality of donations of each donor, providing summarized view of list of donors along with total donations donors made for a given fiscal year.

With reference to the fifth menu associated with configuring entities, FIG. 4S-Z illustrates plurality of user interface configuring various entities. Entities are usually recognizable concepts, either concrete or abstract, such as person, places, things, or events which have relevance to the database. In one example, the tables of a database are entities. In another example, any object that is used to model and store information about.

To make the patent application simpler user interface to add/edit/delete interface is not shown as to configuring entities. User interface to add/edit/delete entities would perform the similar way as presented earlier in other features (for example, add/edit/delete donations illustrated in FIG. 4J) wherein “Save” button will update the entity and “Delete” button will delete the entity based on user's administrative privilege and “Cancel” button will cancel the operation and return back to previous user interface.

FIG. 4S-4SA illustrate a user interface that configure application user entity wherein user is able to add, edit or delete the application user wherein the delete operation is only available to user who has administrative privilege. FIG. 4S illustrates an exemplary user interface to list applications users and FIG. 4SA illustrates an exemplary user interface to edit/delete a selected application user.

FIG. 4T-4TA illustrates a user interface that configure template entity wherein the user is able to add, edit or delete the templates wherein the delete operation is only available to user who has administrative privilege. FIG. 4T illustrates an exemplary user interface to list templates and FIG. 4TA illustrates an exemplary user interface to edit/delete a selected template (e.g. ‘Home’ template which is used to display content of Home page of the website of ORCA-USA, a charitable organization). The template is used to store content along with variables within the content. For example, the content of the donation receipt that user sent to donor is stored in a ‘donation receipt’ template. In another example, content of 990 IRS Tax form is stored in a template along with variables wherein the variable is replaced with the calculated value in real time when the system generates the 990 tax return form. In another example, the content of the website (e.g. content of Home page) is stored in a template. In one embodiment, the customized software facilitates the charitable organization to build a website based on the template stored in the database 225 wherein the content of each page is stored in the template. This facilitates the organization to have a website with unlimited web pages wherein the user of the organization can add/edit/delete any web page of their website in real time. For example, if the organization wants to update content of “Home” web page, all the user needs to do is update the content of “Home” template and website content will be updated dynamically in real time.

FIG. 4U-4UA illustrates a user interface that configure fund entity wherein the user is able to add, edit or delete the fund wherein the delete operation is only available to the user who has administrative privilege. FIG. 4U illustrates an exemplary user interface to list funds and FIG. 4UA illustrates an exemplary user interface to edit/delete a selected fund.

FIG. 4V-4VA illustrates a user interface that configure user role entity wherein the user is able to add, edit or delete the user role wherein the delete operation is only available to user who has administrative privilege. FIG. 4V illustrates an exemplary user interface to list user roles and FIG. 4VA illustrates an exemplary user interface to edit/delete a selected role.

FIG. 4W-4WA illustrates a user interface that configure project (i.e. expense category) entity wherein user is able to add, edit or delete the project wherein the delete operation is only available to user who has administrative privilege. FIG. 4W illustrates an exemplary user interface to list projects (also known as expense category) and FIG. 4WA illustrates an exemplary user interface to edit/delete a selected project.

FIG. 4X-4XA illustrates a user interface that configure donor entity wherein user is able to add, edit or delete the donor wherein the delete operation is only available to user who has administrative privilege. FIG. 4X illustrates an exemplary user interface to list donors and FIG. 4XA illustrates an exemplary user interface to edit/delete a selected donor.

FIG. 4Y-4YA illustrates a user interface that configure document type entity wherein user is able to add, edit or delete the document type wherein the delete operation is only available to user who has administrative privilege. FIG. 4Y illustrates an exemplary user interface to list document types and FIG. 4YA illustrates an exemplary user interface to edit/delete a selected document type.

FIG. 4Z-4ZA illustrates a user interface that configure organization entity wherein user is able to add, edit or delete the organization wherein the delete operation is only available to user who has administrative privilege. FIG. 4Z illustrates an exemplary user interface to list organizations and/or subsidiaries and FIG. 4ZA illustrates an exemplary user interface to edit/delete a selected organization.

With reference to the sixth menu associated with documents, FIG. 4AA illustrates plurality of activities related with archiving documents. The plurality activities displayed in FIG. 4AA are search documents by any given parameter (e.g. document name, document type), display a document search results wherein the search results are sortable in both ascending and descending order upon clicking on a column name (e.g. name, description, document type, file name, date archived etc) of the search results table. In FIG. 4AA, displays a document search results upon clicking on ‘Search Documents’ button. FIG. 4AA displays an edit item icon (e.g. pencil icon, left most column of the document search results table, next to document name) which allows user to view details of the selected document and edit the selected document which is shown in FIG. 4AB. In the edit document page in FIG. 4AB, user is able to update the document by clicking on ‘Save’ button and by clicking on ‘Delete’ button user is able to delete the selected document. It should be noted that the delete button is displayed only for those users who has administrative privilege. Clicking on ‘Cancel’ button of FIG. 4AB cancels the edit document activities and returns back to documents page (i.e. FIG. 4AA). FIG. 4AA also displays an “add document” button which facilitate user to add document and after adding a new document, it returns back to the documents page displayed in FIG. 4AA.

With reference to the seventh menu associated with nomination and electronic voting (also known as E-Voting), FIG. 4AC-4AF illustrates plurality of activities related with nominations and e-voting. The plurality activities displayed in FIG. 4AC are add a nominee by clicking on the ‘Add Nominee’ button, display list of nominees and sign a consent form, which is required to complete the nomination. FIG. 4AD displays an add nominee user interface wherein clicking on ‘Add my nominee’ button add the nominee and return back to list nominee page (i.e. FIG. 4AC). It should be noted that in order to complete the nomination, the nominee must sign the consent form displayed in FIG. 4AC by selecting the ‘Yes’ radio button and clicking on the ‘Sign’ button. Nominee who signed the consent form, displays “candidate signed” next to the nominee's name as illustrated in FIG. 4AC. Label “candidate declined” is displayed next to the nominee's name when the nominee declined the nomination by selecting the “No” radio button and clicking on the “Sign” button.

FIG. 4AE illustrates activity associated with E-Voting wherein list of candidates are displayed along with optional text box to write comments, if voter (i.e. application user) has any. In response to clicking on ‘Cast My Vote’ button, system displays the electronic ballot that voter just submitted, unique voter id, transaction id, IP address of the voter and timestamp which is illustrated in FIG. 4AF. In response to clicking on “Print” button in FIG. 4AF user is able to print the e-voting ballot.

In one embodiment, the nomination and e-voting system can be isolated and deployed independently wherein a separate authentication (i.e. login) screen illustrated in FIG. 4AG, can be used to access the nomination (FIG. 4AC-4D) and e-voting (e.g. FIG. 4AE-4AF) user interfaces. This would help those charitable organizations that only want to have the nomination and e-voting system.

In addition to the first to seventh menu which was described above, any number of personalized and customized menus can be added to the system based on the organization's requirements. For example, ORCA-USA organization has a members option but Bestower Foundation does not have a members option to view member profiles. Thus, ORCA-USA may have a menu associated with search, add/edit/deleted members which is illustrated in FIG. 4AH wherein the user is able to search members by various parameters including, but not limited to, state, country, first name, last name, email, city, LTM (life time member). Clicking on pencil icon in FIG. 4AH will facilitate the user to add/edit/delete a selected member and clicking on ‘Add ORCA Member’ facilitate user to add new member to ORCA-USA (which is not shown). In one embodiment, every column of the search results table is sortable in both ascending and descending order. Clicking on a column first time will sort in ascending order, which is illustrated in FIG. 4AH (sorted by city in ascending order) and clicking on the same column name second time will sort the search results in descending order at client side without making a client-server trip, which is illustrated in FIG. 4AI (sorted by city in descending order). A distinct icon to show ascending or descending sorting order is also displayed next to the column name which is used to sort, which is illustrated in FIG. 4AH-4AI.

In another embodiment, regarding personalized menu item, a charitable organization (e.g. ORCA-USA) may want to have a feature to archive their officers and have a menu items (e.g. “Officers”) which would display all officers elected for the organization. FIG. 4AL illustrates an exemplary user interface which display all officers elected for the charitable organization, ORCA-USA.

FIG. 4AJ illustrates a user interface displaying contact information associated with getting technical support, sending enhancement request or feature inquiries wherein the contact information is personalized based on the organization's preference and requirement.

FIG. 4AK illustrates a user interface to update profiles of users who logged in to the system. Using update profile user interface (i.e. FIG. 4AK), the user is able to update information, including, not limited to, first name, last name, user name (i.e. cadet no for ORCA-USA as per organization's preference), password, picture, biography, phone, email. Upon clicking on ‘Update Profile’ button, the user is able to update profile's information to the database (225 of FIG. 2) in real time.

In addition to all of the personalized menus and features that the organization would like to have, there will always be a “Logout” menu, which is illustrated in FIG. 4F-4G (e.g. FIG. 4F for native application 211 and FIG. 4G for web application 222) to facilitate the user to logout and release all session data used by the customized software.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A System for providing a customizable software for a charitable organization to perform a plurality of required activities to stay compliant with federal, state and Internal Revenue Service (IRS) regulations, the system comprising:
a non-transitory memory for storing instructions to perform the plurality of required activities; and
a processor, the processor configured to execute instructions to:
receive a request from a client to render an authentication screen to access the customizable software wherein the request includes at least a unique identification number (UIN) assigned to the charitable organization;
render the authentication screen dynamically to the client based on the UIN, the authentication screen includes at least a button control and a plurality of text box controls wherein the plurality of text box controls comprising at least a username text box control holding a username of a user and a password text box control holding a password of the user, wherein the username and the password is stored in a database in encrypted form;
receive an user input to perform an authentication of the user using the UIN included in the request from the client, the username entered into the username text box control and the password entered into the password text box control, wherein the authentication matches the username and the password entered by the user with the username and the password value stored in the database in encrypted form, and the authentication uses a method from a plurality methods based on a type of the customizable software, wherein the plurality of methods comprises at least a Web Service method and a Non-Web Service method;
identify, in response to have the user authenticated, a unique user identification (UID), a user role and an organization information of the authenticated user wherein the UID, the user role and the organization information are encrypted and stored at the client to avoid a client-server round trip when the client needs to access the UID, the user role and the organization information; and
render the customizable software to the client based on the identification of the UID, the user role and the organization information of the authenticated user, wherein the customizable software display at least:
a logo information of the charitable organization, a customizable software name as per the charitable organization's preference in order to give full ownership of the customizable software, a version information of the customizable software, wherein the logo information, the software name and the version information is stored in the database and configurable by the charitable organization; and
a menu bar including a plurality of menu items wherein the plurality of menu items are hierarchical and the plurality of menu items includes at least:
a first menu to perform a first plurality of activities associated with donations received by the charitable organization;
a second menu to perform a second plurality of activities associated with expenses done by the charitable organization;
a third menu to perform a third plurality of activities associated with preparing and filing tax return to internal Revenue Service (IRS);
a fourth menu to perform a fourth plurality of activities associated with generating various customizable reports required by the charitable organization;
a fifth menu to perform a fifth plurality of activities associated with configuring and customizing various data based on the charitable organization's requirements;
a sixth menu to perform a sixth plurality of activities associated with archiving plurality of documents based on the charitable organization's requirements; and
a seventh menu to perform a seventh plurality of activities associated with nomination and electronic voting of officers or directors of the charitable organization.

2. The system of claim 1, wherein the request is made using Uniform Resource Locator (URL) and the UIN is passed as Query String of the URL, wherein the UIN is encrypted using an encryption algorithm form a plurality of encryption algorithms wherein the plurality of encryption algorithms comprises Triple DES, RSA, Blowfish, Twofish and AES.

3. The system of claim 1, wherein the Web Service Method is used when the customizable software is a native application and the Non-Web Service Method is used when the customizable software is a web application.

4. The system of claim 1, wherein the first plurality of activities includes at least:
search donations by any given parameter; display a donation search results;
edit donations; add donations; and delete donations, wherein the donation search results is displayed in a table and the donation search results is sortable in both ascending and descending order in response to clicking on a column name of the table.

5. The system of claim 1, wherein the second plurality of activities includes at least:
search expenses by any given parameter, display a expense search results;
edit expense; add expense; and delete expenses, wherein the expense search results is displayed in a table and the expense search results is sortable in both ascending and descending order in response to clicking on a column name of the table.

6. The system of claim 1, wherein the third plurality of activities includes at least:
search and generate a tax return form for any given year, and
file the tax return form dynamically based on data stored in the database when IRS is ready accept the tax return form, wherein the tax return form includes at least form 990.

7. The system of claim 1, wherein the fourth plurality of activities includes at least:
generate a report dynamically from a plurality of reports based on a given report parameter, wherein the plurality of reports include at least annual report, standard report, and income by donors, and expense by projects;
select plurality of donors that the user wants to send the donation receipt; and
send donation receipts to all selected donors using a single click.

8. The system of claim 1, wherein the fifth plurality of activities includes at least:
configuring an entity from a plurality of entities wherein the plurality of entities include app user, templates, funds, user roles, projects, donors, document types, and organizations, wherein the configuring the entity comprises add, edit and delete of the entity.

9. The system of claim 1, wherein the sixth plurality of activities includes at least:
search documents by any given parameter, display a document search results;
edit documents; add documents; and delete document, wherein the document search results is displayed in a table and the donation search results is sortable in both ascending and descending order in response to clicking on a column name of the table.

10. The system of claim 1, wherein the seventh plurality of activities associated with nomination and electronic voting of officers or directors of the charitable organization includes at least:
add a nominee; sign consent form by the nominee; and upon completion of the nomination, enable members of the charitable organization to electronically vote for the nominees to elect the officers or the directors of the charitable organization.

11. The system of claim 1, wherein staying compliant with federal, state and Internal Revenue Service (IRS) regulations is associated with maintaining the charitable organization's tax-exemption status as per section 501 (c)(3) of the Internal Revenue Service (IRS) Code.

12. A computer implemented method for providing a customizable software for a charitable organization to perform a plurality of required activities to stay compliant with federal, state and Internal Revenue Service (IRS) regulations, the method comprising:
receiving a request from a client to render an authentication screen wherein the request includes a unique identification assigned to the charitable organization;
rendering the authentication screen to the client, the authentication screen includes at least a button control and a plurality of text box controls wherein the plurality of text box controls comprising a username and a password, wherein the username and the password is stored in a database encrypted to reduce any security threat;
receiving an user input to perform an authentication of a user using the username and the password, wherein the authentication uses a method from a plurality methods based on a type of the client, wherein the plurality of methods comprises at least a Web Service method and a Non-Web Service method;
identifying, in response to have the user authenticated, a unique user identification (UID), a user role and an organization information of the authenticated user wherein the UID, the user role and the organization information are encrypted and stored at the client to avoid a client-server round trip when the client needs to access the UID, the user role and the organization information; and
rendering the customizable software to the client in response to have the user authenticated, wherein the customizable software display at least:
a logo of the charitable organization and a customizable software name as per the charitable organization's preference in order to give full ownership of the customizable software, wherein the software name is stored in the database and configurable by the charitable organization;
a menu bar including a plurality of menu items wherein the plurality of menu items are hierarchical and the plurality of menu items includes at least:
a first menu to perform a first plurality of activities associated with donations received by the charitable organization;
a second menu to perform a second plurality of activities associated with expenses done by the charitable organization;
a third menu to perform a third plurality of activities associated with preparing and filing tax return to Internal Revenue Service (IRS);
a fourth menu to perform a fourth plurality of activities associated with generating various customizable reports required by the charitable organization;
a fifth menu to perform a fifth plurality of activities associated with configuring and customizing various data based on the charitable organization's requirements;
a sixth menu to perform a sixth plurality of activities associated with archiving plurality of documents based on the charitable organization's requirements; and
a seventh menu to perform a seventh plurality of activities associated with nomination and electronic voting of officers or directors of the charitable organization.

13. A non-transitory machine-readable storage medium comprising machine-readable instructions for causing a processor to execute a method for providing a customizable software for a charitable organization to perform a plurality of required activities to stay compliant with federal, state and Internal Revenue Service (IRS) regulations, comprising:
receiving a request from a client to render an authentication screen wherein the request includes a unique identification assigned to the charitable organization;
rendering the authentication screen to the client, the authentication screen includes at least a button control and a plurality of text box controls wherein the plurality of text box controls comprising a username and a password, wherein the username and the password is stored in a database encrypted to reduce any security threat;
receiving an user input to perform an authentication of a user using the username and the password, wherein the authentication uses a method from a plurality methods based on a type of the client, wherein the plurality of methods comprises at least a Web Service method and a Non-Web Service method;
identifying, in response to have the user authenticated, a unique user identification (UID), a user role and an organization information of the authenticated user wherein the UID, the user role and the organization information are encrypted and stored at the client to avoid a client-server round trip when the client needs to access the UID, the user role and the organization information; and
rendering the customizable software to the client in response to have the user authenticated, wherein the customizable software display at least:
a logo of the charitable organization and a customizable software name as per the charitable organization's preference in order to give full ownership of the customizable software, wherein the software name is stored in the database and configurable by the charitable organization;
a menu bar including a plurality of menu items wherein the plurality of menu items are hierarchical and the plurality of menu items includes at least:
a first menu to perform a first plurality of activities associated with donations received by the charitable organization;
a second menu to perform a second plurality of activities associated with expenses done by the charitable organization;
a third menu to perform a third plurality of activities associated with preparing and filing tax return to Internal Revenue Service (IRS);
a fourth menu to perform a fourth plurality of activities associated with generating various customizable reports required by the charitable organization;
a fifth menu to perform a fifth plurality of activities associated with configuring and customizing various data based on the charitable organization's requirements;
a sixth menu to perform a sixth plurality of activities associated with archiving plurality of documents based on the charitable organization's requirements; and
a seventh menu to perform a seventh plurality of activities associated with nomination and electronic voting of officers or directors of the charitable organization.
